(19) United States
(12) Patent Application Publication
(10) Pub. No.: US 2008/0167014 A1
(43) Pub. Date: Jul. 10, 2008

(54) VOICEMAIL SYSTEMS AND METHODS

(76) Inventors: Gregory Novick, Santa Clara, CA (US); Jeremy Wyld, San Jose, CA (US); Henri Lamiraux, San Carlos, CA (US); Nitin Ganatra, San Jose, CA (US)

Correspondence Address: APPLE COMPUTER, INC./BLAKELY, 1279 OAKMEAD PARKWAY, SUNNYVALE, CA, 94085-4040, US

(21) Appl. No.: 11/770,680

(22) Filed: Jun. 28, 2007

Related U.S. Application Data
(63) Continuation-in-part of application No. 11/620,713, filed on Jan. 7, 2007.

(51) Int. Cl. H04M 11/10

(52) U.S. Cl. 455/413

(57) ABSTRACT

Systems, methods and machine (e.g. computer) readable media for providing or managing or using voicemails are described. In one embodiment, a method includes receiving at least notifications of voicemails at a mobile data processing system and storing a data structure at the mobile data processing system for deleted voicemails. In another embodiment, a method includes determining an extent of usage of a voicemail mailbox at a data processing system and determining a period of time representing how long a voicemail has been marked as deleted and determining, based on the extent of usage and based on the period of time, whether to delete the voicemail.

This application is a continuation-in-part of U.S. patent application Ser. No. 11/620,713, filed Jan. 7, 2007.

### BACKGROUND OF THE INVENTION

Modern telephone systems, such as a land line telephone or a wireless cellular telephone, include the ability to leave a voice message for the owner or user of the telephone. Typically, a caller to the phone number of that phone will hear a voicemail greeting telling the caller to leave a message. After the greeting, the caller has the opportunity to leave a message which is recorded on a voicemail system. In certain embodiments, the voicemail is recorded locally on a storage device which is part of a telephone in the case of certain land line phones, or the voicemail may be recorded on a voicemail server maintained in the infrastructure of a public telephone carrier, such as AT&T or Verizon or Verizon Wireless.

These voicemails are recorded and maintained for later use by the owner or operator of the telephone device for which the voicemail account was established. For example, the user of the telephone device may connect to the voicemail server through a telephone call to the voicemail server to listen to one or more voicemails stored at the voicemail server. Current systems provide a very minimal user interface to the user with respect to the voicemails stored at the voicemail server. For example, on a typical wireless cellular telephone, the user is presented with a notification which indicates the number of voicemails. FIG. 1 shows an example of a display of a telephone device, such as a wireless cellular telephone. The display 10 includes an indication 11 which shows that there are two voicemails, which may be new voicemails not listened to by the user. The user must then obtain access to those voicemails by connecting to the voicemail server through a telephone call. During that phone call, the user is prompted to enter commands to cause playback of the voicemail messages. The playback sequence is constrained by the order in which the voicemails were recorded or received at the voicemail server. In other words, the user must access each voicemail one after another in a series based upon the time of receipt of the voicemail. After (or before) playback, the user may instruct the voicemail server to either save or delete a voicemail. If the user elects to delete a voicemail, the voicemail will be deleted from the voicemail server when the user disconnects from the voice connection used to listen to (play back) the voicemail. Once the user disconnects, the voicemail is no longer accessible to the user. If the user elects to save a voicemail, then the voicemail server saves the voicemail, which allows the user to disconnect from the voice connection and still be able to retrieve and listen to the voicemail on subsequent connections to the voicemail server. A saved voicemail may later be deleted by the user or is deleted automatically by the voicemail server in response to exceeding storage time. In certain cases, some wireless telephone voicemail systems allow a user to re-save a voicemail (which has not been deleted) in order to reset elapsed storage time to zero, thereby preventing automatic deletions in response to storage time. These voicemail systems do not allow sufficient flexibility for users when voicemails are deleted.

### SUMMARY OF THE DESCRIPTION

Voicemail systems, methods, and computer readable media are described herein. In one embodiment, a machine implemented method includes receiving data representative of a voicemail at a data processing system and receiving an instruction to delete the voicemail at the data processing system and storing data indicating that the voicemail has been marked for deletion at the data processing system in response to the receiving of the instruction and receiving a further instruction to delete the voicemail at the data processing system and deleting the data representative of the voicemail in response to the further instruction. The data processing system may be a mobile data processing system, such as a wireless cellular telephone, or a server system such as a voicemail server. The data representative of the voicemail may be metadata of the voicemail (e.g. metadata such as the caller's name or phone number or time/date of phone call or length of message or a combination of this information) and/or the content of the voicemail. The instruction and the further instruction may be received from the user. The data indicating that the voicemail has been marked for deletion may be stored in a data structure which is a folder or container for voicemails that have been marked for deletion, and this data structure may be stored at the mobile data processing system. The user may establish a connection with a voicemail server and initiate the instruction, causing the voicemail to be marked for deletion, and then disconnect and still keep the voicemail saved at the voicemail server but marked for deletion at the mobile data processing system which, in one embodiment, has not informed the voicemail server of the instruction. At some later point, the mobile data processing system may receive the further instruction and, in response, cause the deletion, at the voicemail server, of the voicemail and also cause the deletion of data representative of the voicemail at the mobile data processing system. In response to the instruction, the voicemail may be removed from an inbox list and added to a delete list at the mobile data processing system, and the voicemail is removed from the delete list in response to the further instruction. In certain embodiments, the data representative of the voicemail may be downloaded content of the voicemail which is stored at the mobile data processing system which is a client of the voicemail server.

A mobile data processing system, in one embodiment, includes a wireless transceiver, a processor coupled to the wireless transceiver, and a memory coupled to the processor. The processor is configured to receive at least notifications of voicemails at the mobile data processing system and is configured to store a data structure, at the mobile data processing system, for deleted voicemails. In one implementation of an embodiment, the mobile data processing system includes a wireless cellular telephone transceiver, and data for the voicemails is stored in the data structure in response to an instruction to delete a voicemail, and the data for the voicemail is deleted from the data structure in response to a further instruction to delete the voicemail. The data structure may be a folder or container for voicemails that have been marked for deletion. The mobile data processing system may transmit an instruction, in response to the further instruction, to delete the voicemail at a voicemail server which is operated by a wireless cellular telephone carrier.

In another embodiment, a machine implemented method includes receiving at least notifications of voicemails at a mobile data processing system and storing a data structure for deleted voicemails at the mobile data processing system. The method may further include receiving an instruction to delete a voicemail, wherein data for the voicemail is stored in the data structure in response to the instruction, and receiving a further instruction to delete the voicemail, wherein data for the voicemail is deleted from the data structure in response to the further instruction. The mobile data processing system may include a wireless cellular transceiver which transmits an instruction, in response to the further instruction, to delete the voicemail at a voicemail server which caused the notifications to be sent to the mobile data processing system. The voicemail server may be operated by a wireless cellular telephone carrier. In certain instances, content of a voicemail may be downloaded from the voicemail server to the mobile data processing system, and this content may also be deleted in response to the further instruction.

In another embodiment, a machine implemented method according to another aspect described herein includes determining an extent of usage of a voicemail mailbox at a data processing system and determining a period of time representing how long a voicemail has been marked as deleted and determining, based on the extent of usage and based on the period of time, whether to delete the voicemail. This method may be performed by a combination of a voicemail server and a mobile data processing system (which may include a wireless cellular telephone) which is a client of the voicemail server; for example, the voicemail server can perform the determining of the extent of usage and the mobile data processing system can perform the determining of whether to delete the voicemail. In some embodiments, the information used in the method (e.g. extent of usage or the period of time) may be transmitted from one system to another system in order to allow the another system to make a determination to delete (or not delete); either a server system or a client system can make the decision (e.g. determination) of whether to delete a voicemail. In certain embodiments, the method may further include deleting the voicemail in response to a determination to delete the voicemail, and the voicemail may be deleted at the voicemail server and optionally also at the mobile data processing system which may have stored metadata of the voicemail (e.g. caller's name, phone number, etc.) and optionally also content of the voicemail.

In another embodiment, a machine implemented method includes receiving, at a first data processing system, data representing an extent of usage of a voicemail mailbox at a second data processing system and determining a period of time which represents how long a voicemail has been marked as deleted at the first data processing system and determining, based on the extent of usage and based on the period of time, whether to delete the voicemail. The method may also include deleting the voicemail at the second data processing system in response to the determining of whether to delete the voicemail, and the second data processing system may be a voicemail server operated by a wireless cellular telephone carrier. The data representing the extent of usage may indicate whether the extent of usage exceeds a threshold. The period of time may be determined by sorting the voicemails by their age in a deleted folder (e.g. how long each has been marked as deleted and hence in the deleted folder or other representation of voicemails marked for deletion) and by selecting for actual deletion (rather than just marking as to be deleted) based upon an age criteria (e.g. all voicemails marked for deletion for more than 2 weeks are determined to be deleted and are deleted at the voicemail server and optionally also at the mobile data processing system, which may store metadata of the voicemail and optionally also content of the voicemail). The voicemail may be deleted automatically without any user input or may be deleted after presenting information about the deletion to the user (which presenting may give the user an opportunity to prevent the deletion and/or cause other voicemails to be deleted).

In another embodiment, a machine implemented method includes transmitting, from a first data processing system, time data which represents when a voicemail has been marked as deleted at the first data processing system and storing, at the first data processing system, voicemail data for the voicemail after the transmitting, and deleting, at the first data processing system, the voicemail data in response to an instruction from a second data processing system, wherein the deleting occurs after the storing. The first data processing system may include a wireless cellular telephone, and the second data processing system may be a voicemail server operated by a wireless cellular telephone carrier which provides wireless telephone service for the wireless cellular telephone. The time data may include a date of deletion at the first data processing system, and the voicemail data may include at least one of metadata of the voicemail or content of the voicemail, which may be downloaded to and stored at the first data processing system.

In another embodiment, a machine implemented method includes receiving, at a first data processing system, time data which represents when a voicemail has been marked as deleted at a second data processing system and determining whether a voicemail mailbox of the first data processing system has a usage which exceeds a threshold, wherein the voicemail is at least temporarily stored in the voicemail mailbox, and determining whether to delete the voicemail based on the time data and whether the usage exceeds the threshold. The first data processing system may comprise a voicemail server, and the second data processing system may comprise a mobile wireless cellular telephone, and the voicemail server may be operated by a wireless cellular telephone carrier. The time data may include a date of deletion at the second data processing system. The voicemail may be stored as voicemail data which includes at least one of metadata of the voicemail and content of the voicemail which may be downloaded to and stored at the first data processing system.

In another embodiment, a machine implemented method includes receiving first data which indicates whether use of a voicemail mailbox exceeds a threshold, and determining whether a voicemail marked for deletion has been marked for deletion for more than a period of time, and deleting the voicemail if (a) the first data indicates that the threshold has been exceeded and (b) the voicemail has been marked for deletion for more than the period of time. The first data may be received at a mobile data processing system which includes a wireless cellular telephone, and the mobile data processing system may perform the process of the determining and the process of the deleting. The deleting may be performed after presenting information about the deleting to a user, and the deleting may delete the voicemail in the voicemail mailbox at the voicemail server and may also delete at least one of metadata of the voicemail and content of the voicemail at the mobile data processing system. The content of the voicemail may be downloaded to and stored at the mobile data processing system.

Other methods are described herein and systems for performing these methods are described herein and computer readable media for performing these methods are also described herein. Furthermore, various apparatuses and devices which are configured to perform these methods are also described herein.

### BRIEF DESCRIPTION OF THE DRAWINGS

The present invention is illustrated by way of example and not limitation in the figures of the accompanying drawings in which like references indicate similar elements.

FIG. 1 shows an example in the prior art of a voicemail user interface.

FIG. 2A shows, in block diagram form, an example of a telephone device or other communication device which includes at least one wireless transceiver.

FIG. 2B shows, in block diagram form, an example of a data processing system, which may be a handheld personal computer which includes at least one wireless transceiver.

FIG. 2C shows an example of a data processing system; this data processing system may be used to implement a voicemail server in at least certain embodiments.

FIG. 2D shows a formfactor for a data processing system, such as a handheld personal computer in a tablet formfactor.

FIG. 2E shows an example of a telephone device which may be used in at least certain embodiments of the present inventions.

FIGS. 2F and 2G show another formfactor for a telephone device which may be used with at least certain embodiments of the present inventions.

FIG. 3 shows an example of a network which includes telephone devices and at least one voicemail server which may be used in at least certain embodiments of the present inventions.

FIGS. 4A, 4B, 4C, and 4D illustrate examples of a user interface which may be used in at least certain embodiments of the present inventions.

FIGS. 5A and 5B are flow charts illustrating a method according to certain embodiments of the present inventions.

FIG. 6 is a flow chart illustrating a method according to at least certain embodiments of the present inventions.

FIG. 7 is a flow chart illustrating a method according to at least certain embodiments of the present inventions.

FIG. 8 is a flow chart illustrating a method according to at least certain embodiments of the present inventions.

FIG. 9 is a flow chart illustrating a method according to at least certain embodiments of the present inventions.

FIGS. 10A and 10B are flow charts illustrating methods according to at least certain embodiments of the present inventions.

FIG. 11 is a flow chart illustrating a method according to at least certain embodiments of the present inventions.

FIG. 12A is a flow chart showing a method according to certain embodiments of the present invention.

FIGS. 12B and 12C respectively illustrate a memory structure at a voicemail client device and a memory structure at a voicemail server device.

FIG. 13 is a flow chart which shows a method according to certain embodiments of the present invention.

FIGS. 14A, 14B and 14C are flow charts that show various methods according to certain embodiments of the present invention.

FIGS. 15A, 15B, and 15C are examples of user interfaces at, for example, a voicemail client system according to certain embodiments of the present invention.

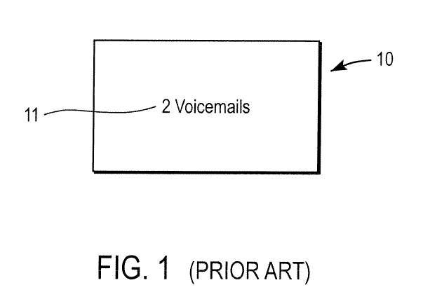

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a through understanding of various embodiments of the present invention. However, in certain instances, well-known or conventional details are not described in order to provide a concise discussion of embodiments of the present inventions.

The present invention can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), flash memory, magnetic or optical cards, or any type of media suitable for storing electronic instructions, and each coupled to a bus.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc. The medium may be a wire or an air interface which provides one or two-way transmission of at least some of the data and/or software described herein.

At least certain embodiments of the inventions may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, such as a click wheel input device on an iPod® or iPod Nano® media player from Apple Inc. of Cupertino, Calif., a touch screen input device, pushbutton device, movable pointing input device or other input device. The media selection device may be used to select the media stored on the storage device and/or the remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s). Examples of a portable media player are described in published U.S. patent application numbers 2003/0095096 and 2004/0224638, both of which are incorporated herein by reference.

In certain embodiments, the data processing systems 20 and 30 may be implemented in a small formfactor which resembles a handheld computer having a tablet-like input device which may be a multi-touch input panel device which is integrated with a liquid crystal display. Examples of such devices are provided in U.S. patent application Ser. No. 11/586,862, filed Oct. 24, 2006, and entitled “AUTOMATED RESPONSE TO AND SENSING OF USER ACTIVITY IN PORTABLE DEVICES,” which is assigned to the same assignee as the instant application. This foregoing application is hereby incorporated herein by reference.

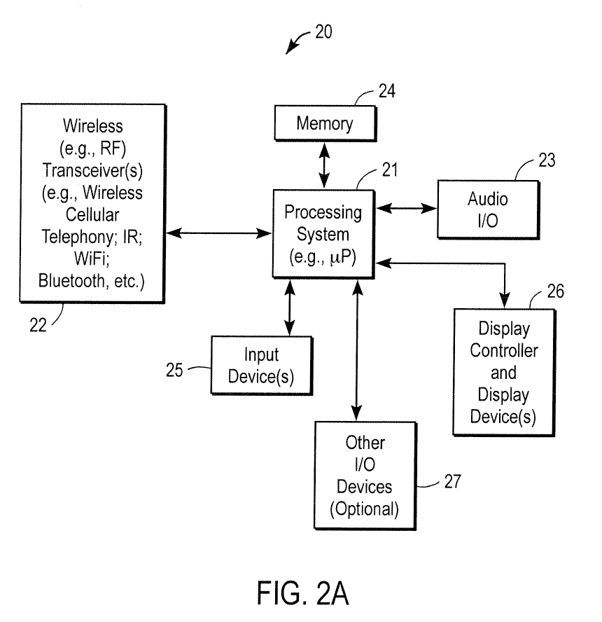

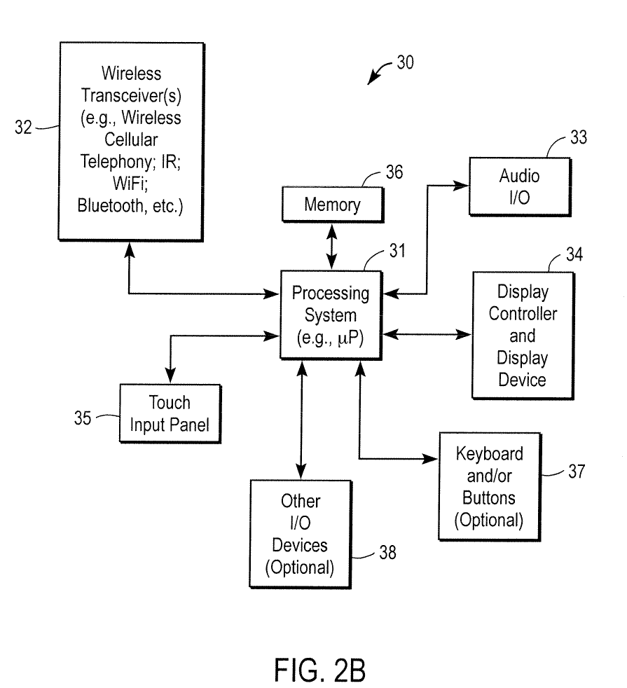

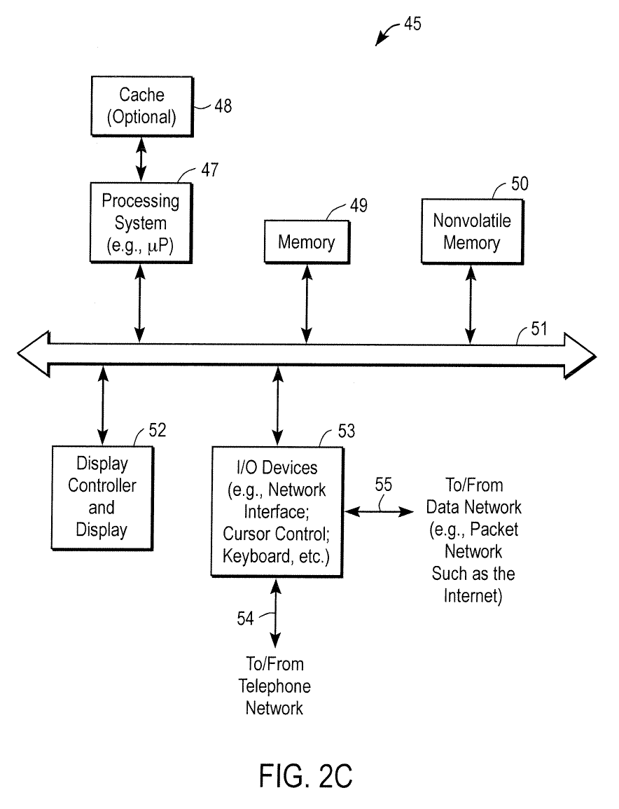

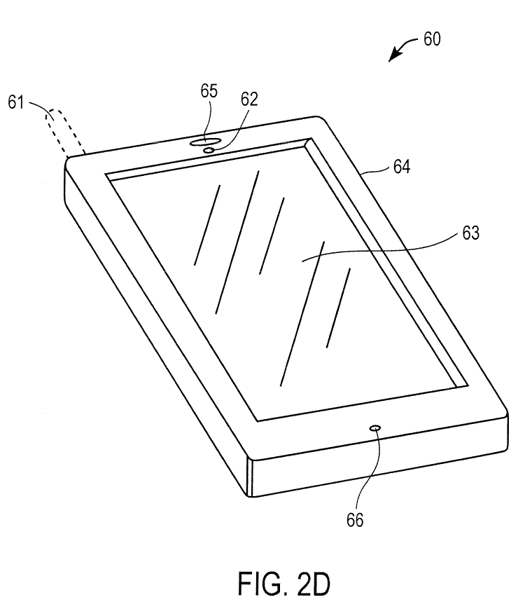

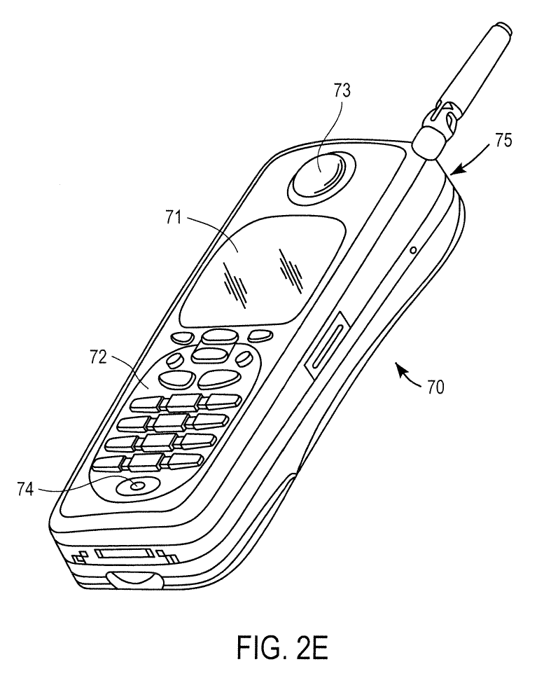

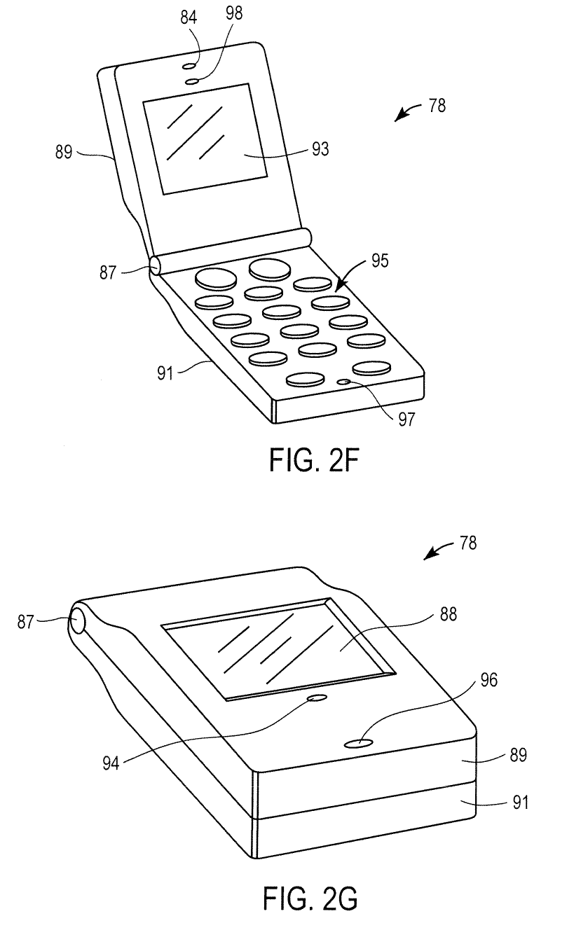

FIG. 2A shows an example of a data processing system which may be a telephone device. The data processing system 20 includes a processing system, which may be one or more microprocessors, or which may be a system on a chip. The data processing system 20 also includes memory 24 which is coupled to the processing system 21; the memory may be used for storing data and programs for execution by the processing system. This memory may also store metadata and audio data for voicemails locally stored on the data processing system 20. The data processing system 20 also includes an audio input/output subsystem 23 which may include a microphone and a speaker for, for example, playing back music or providing telephone functionality through the speaker and microphone or for interacting with a voicemail server. A display controller and display device 26 provides a visual user interface for the user; this user interface may include a graphical user interface which is similar to that shown on a Macintosh computer when running the Mac OS X operating system software. System 20 also includes one or more wireless transceivers, such as a WiFi transceiver or an infrared transceiver or a Bluetooth transceiver, and/or a wireless cellular telephony transceiver. It will be appreciated that additional components, not shown, may also be part of the system 20 in certain embodiments, and in certain embodiments fewer components than that shown in FIG. 2A may also be used in a data processing system. The system 20 also includes one or more input devices 25 which are provided to allow a user to provide input to the system. These input devices may be a keypad or a keyboard or a touch panel or a multi-touch input panel or other known input devices or a combination of such input devices. The system 20 may also include an optional input/output (I/O) device 27 which may be a connector for a dock or a connector for a USB interface, etc. It will be appreciated that one or more buses, not shown, may be used to interconnect the various components shown in FIG. 2A, as is well-known in the art. The data processing system shown in FIG. 2A may be a handheld personal computer or a personal digital assistant (PDA), or a cellular telephone with PDA-like functionality, or a WiFi based telephone, or a handheld computer which includes a cellular telephone, or a media player, such as an iPod, or an entertainment system, such as a PlayStation entertainment system, or devices which combine aspects or functions of these devices, such as a media player combined with a PDA and a cellular telephone in one device, or a consumer electronic product or other electronic products. In other embodiments, the data processing system 20 may be a network computer or an embedded processing device within another device or consumer electronic product. In certain embodiments, if the data processing system 20 is a telephone device which is a land line telephone, the wireless transceivers 22 may be omitted.

FIG. 2B shows another example of a data processing system which may be used with one or more of the embodiments described herein. The data processing system 30 may be a handheld personal computer which may have a tablet formfactor such as that shown in FIG. 2D. The data processing system 30 may include a processing system, which may be a microprocessor which is coupled to a memory 36 and which is also coupled to a touch input panel 35, which may be separate from a display device or integrated with a display device. The display device 34 is also coupled to the processing system 31. The touch input panel 35 may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the processing system 31. The display controller and display device 34 may provide a visual user interface for the user, and this visual interface may include a graphical user interface which is similar to that shown on a Macintosh computer when running OS X operating system software. The memory 36 may store data and computer programs and recorded voicemails which have been locally stored on the data processing system 30. The data processing system may also include an optional keyboard and/or buttons, such as dedicated or soft buttons, on the system to allow the user to provide inputs to the keyboard and/or the buttons. The optional keyboard may swing out or slide out from a portion of the device. In other embodiments, the keyboard is not present as the touch input panel is used to provide a keyboard for use by the user. An audio input/output subsystem 33 may include a speaker and a microphone or several speakers and microphones to provide telephone functionality, media playing functionality, and to allow a user to access a voicemail system, such as a voicemail server through a telephone network. The data processing system 30 may also include other input/output devices 38, and it is shown as including one or more wireless transceivers, such as a WiFi transceiver, an infrared transceiver, a Bluetooth transceiver, and/or a wireless cellular telephony transceiver. It will be appreciated that additional components, not shown, may also be part of the system 30 in certain embodiments, and in certain embodiments, fewer components than that shown in FIG. 2B may also be used in a data processing system according to various embodiments of the present inventions. The data processing system 30 may be a PDA or a cellular telephone with PDA-like functionality or a cellular telephone without PDA functionality or a handheld personal computer which includes a cellular telephone and a media player, such as an iPod, or consumer electronic products or other electronic products which allow for access to voicemail functionality.

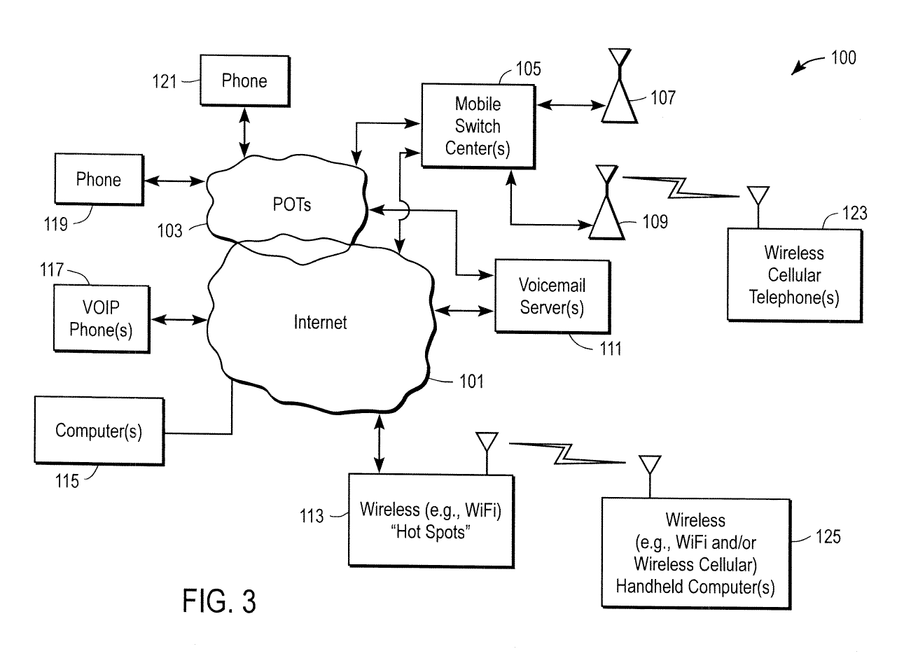

FIG. 2C shows an example of a data processing system which may be used to implement a voicemail server. It will be appreciated that other types of voicemail servers, implemented with a different architecture, may also be used with one or more of the embodiments of the present inventions described herein. Note that while FIG. 2C illustrates the various components of the data processing system 45, it is not intended to represent any particular architecture or manner of interconnecting the components, as such details are not germane to the present inventions. It will also be appreciated that a system having additional components not shown in FIG. 2C or having fewer components than that shown in FIG. 2C may also be used to provide a voicemail server or functionality for a voicemail server. The data processing system 45 includes a bus 51 which is coupled to one or more microprocessors which form a processing system 47. The bus 51 is also coupled to memory 49 and to non-volatile memory 50, which may be a magnetic hard drive or other non-volatile memory device which may store data and software to operate the data processing system 45 as well as storing voicemails left for a plurality of customers of a public telephone carrier, such as a public wireless cellular telephone carrier. The bus is also coupled to a display controller and a display 52, which may be optional in certain instances. Further, the bus is coupled to one or more input/output devices and/or controllers 53. This may include network interface controllers or network interface cards, cursor control devices, keyboards, etc. in order to allow input and output for the data processing system 45. In at least certain embodiments, the data processing system 45 will include at least one network interface card or interface device to allow data to and from a data network to be processed by the data processing system 45. For example, an Ethernet network interface may provide one or more ports 55 which act as an interface to a data network, such as a packet network, such as the Internet. Hence, data from the data network may be received through port 55 and data for transmission to the network may be received through the port 55. Similarly, an input/output controller and device may provide a port 54 for connection to a telephone network, such as a POTs telephone network. This allows the data processing system 45, if it is functioning as a voicemail server, to be coupled to both the Internet and a conventional telephone network, such as a POTs network, to receive and record voicemail messages from callers on both the Internet and the POTs network as will be described further in connection with FIG. 3. The memory 49 may be implemented as dynamic RAM (DRAM) which provides fast access to data but which requires power continually in order to refresh or maintain the data in the memory. The non-volatile memory 50 may be a magnetic hard drive or other non-volatile memory which retains data even after power is removed from the system. While the architecture of FIG. 2C shows that the non-volatile memory 50 is a local device coupled directly to the rest of the components in the data processing system, it will be appreciated that other embodiments may utilize a non-volatile memory which is remote from a system, such as a network storage device or a storage area network which is coupled to the data processing system through a network interface, such as a modem or an Ethernet interface. The bus 51, as is well-known in the art, may include one or more buses connected to each other through various bridges, controllers, and/or adapters as is known in the art.

It will be apparent from this description that aspects of the inventions may be embodied, at least in part, in software. That is, the techniques may be carried out in a computer system or other data processing system in response to its processor or processing system executing sequences of instructions contained in a memory, such as memory 24, or memory 36, or memory 49, etc. In various embodiments, hardwired circuitry may be used in combination with the software instructions to implement the present inventions. Thus, the techniques are not limited to any specific combination of hardware circuitry and software, nor to any particular source for the instructions executed by the data processing systems.

FIGS. 2D, 2E, 2F, and 2G illustrate various formfactors for telephone devices which may be used with at least certain embodiments of the present inventions. These telephone devices may be wireless cellular telephones or cordless land line phones or corded land line phones or WiFi phones which are designed to operate wirelessly through a WiFi or WiMax network to transmit and receive phone calls. Each of these telephone devices may be used to initialize a voicemail account and to access and use the voicemail account as described herein in connection with various embodiments. The formfactor of FIG. 2D may be considered to be a handheld tablet cellular telephone, although in other embodiments it may be larger, such as a tablet laptop computer. The formfactor shown in FIG. 2D may or may not include a slide out or swing out keyboard and/or touch wheel. It also may or may not include dedicated or soft buttons on the device. As shown in FIG. 2D, the data processing system 60 includes a display 63 which occupies a substantial portion (e.g. more than 75%) of one surface of the data processing system 60. The data processing system 60 may have a substantially rectangular frame 64 on which is disposed the display 63 which may include an integrated touch input panel, such as a multi-touch input panel. A microphone 66 and a speaker 65 are also disposed on one surface of the data processing system 60. An optional external antenna 6 may also be included or, in certain embodiments, may not be included. The data processing system 60 may also include one or more sensors, such as the sensor 62, which may be, in one embodiment, a proximity sensor or an ambient light sensor or other sensors or a combination of such sensors. The microphone 66 and the speaker 65 may be part of the audio input/output subsystem of the data processing system, such as the audio input/output 23 of FIG. 2A or the audio input/output 33 of FIG. 2B. When the data processing system 30 of FIG. 2B is implemented within the formfactor shown in FIG. 2D, the touch input panel 35 may be integrated with the display device 34 such that the display and the touch input panel are overlapping and registered to each other. The data processing system 60 shown in FIG. 2D may be implemented in a handheld formfactor which has a size such that it may be held in one hand of a user. In at least one embodiment, this system may have a size in a first dimension of less than about 8 inches and a size in a second dimension of less than about 4 inches and a size in a third dimension of less than about 1.5 inches. Each of these dimensions may be an axis of one of the axes in an X, Y, Z coordinate space. In other embodiments, the data processing system 60 may have a size in a first dimension of less than about 5 inches and a size in a second dimension of less than about 2.5 inches and a size in a third dimension of less than about 1 inch.

FIG. 2E shows another formfactor for a telephone device, which may be a wireless cellular telephone or corded land line phone. Such a telephone device may be used in one or more of the embodiments described herein to initialize a voicemail account and to access and use a voicemail account as described herein. The telephone device 70 of FIG. 2E includes a display 71 and a keypad 72 and a speaker 73 and a microphone 74. In at least certain embodiments, the telephone device 70 may open up at the seam 75 to expose an internal QWERTY keyboard and/or touch wheel or other input device. Further, an additional display within the phone, which is exposed when the seam 75 is opened, may also be present inside the telephone device 70. In other embodiments, the telephone device 70 may include a sliding out or swinging out keyboard or other input device. In other embodiments, the telephone device 70 may include a small thumb QWERTY keyboard instead of the keypad 72; an example of such a small thumb QWERTY keyboard is found on Blackberry telephone/email devices.

FIGS. 2F and 2G illustrate another formfactor for a telephone device. This formfactor may be referred to as a clamshell or a flip phone formfactor. This telephone device 78 includes a display housing 89 and a keypad housing 91 which are coupled together by a hinge 87. The telephone device 78 may be a wireless cellular telephone which may include an antenna (not shown) on the display housing 89. The hinge 87 allows a user to open and close the cellular telephone so that it can be placed in at least one of two different configurations shown in FIGS. 2F and 2G. The keypad housing 91 may include a keypad 95 which receives inputs from a user and a microphone 97 which receives voice input from the user. The keypad 95 may be implemented as a set of mechanical buttons or as a touch input panel or a multi-touch input panel. The display housing 89 may include, on its interior surface, a display 93, such as a liquid crystal display, and a speaker 98 and a sensor, such as a proximity sensor or other sensors. FIG. 2G shows the telephone device 78 in its closed configuration; in this configuration, it can be seen that the display 88 is on the exterior surface of the display housing 89, and that a speaker 97 is also on that exterior housing. Further, a sensor, such as a proximity sensor or an ambient light sensor 94, is also on the exterior surface of the display housing 89. The telephone device 78 may include the data processing system 20 shown in FIG. 2A or the data processing system 30 shown in FIG. 2B. In addition, the telephone device 78 may further include a slide out or swing out keyboard or other input device.

The system 100 shown in FIG. 3 represents a modern telephone system which includes a data network such as the Internet 101 and the conventional, plain old telephone system (POTs) 103 which are in some way or another interconnected as shown by the overlap between the Internet 101 and POTs 103. Land line phones or cordless land line phones, such as phones 119 and 121, are shown coupled to POTs 103. One or more voice over IP (VOIP) telephones 117 are shown coupled to the Internet 101. One or more computers 115, such as general purpose data processing systems, are also coupled to the Internet 101. The computers 115 may be, for example, a desktop or laptop computer such as a Macintosh computer or a computer running a Windows operating system and may include software to provide a VOIP telephone through the computers 115. One or more wireless access points 113, such as a WiFi hot spot, may also be coupled to the Internet 101 to provide connectivity to WiFi telephones or wireless handheld computers or other wireless computer which include WiFi transceivers, etc. At least one wireless telephone network is coupled to the POTs 103 as shown in FIG. 3 through the one or more mobile switch centers 105 which are in turn coupled to one or more cell towers, such as cell towers 107 and 109. The cell towers 107 and 109 are in wireless cellular communication, through wireless cellular telephony, with wireless cellular telephones, such as one or more wireless cellular telephones 123. One or more wireless handheld computers 125 may be in communication with a wireless access point or a plurality of wireless access points 113 and may also be in communication with a cellular telephone network through, for example, one of the cell towers 107 and 109. The mobile switching center 105 will typically include one or more connections to POTs 103 and one or more connections to the Internet 101. One or more voicemail servers 111 are also coupled to the Internet 101 and to the POTs 103. The voicemail servers are typically provided and controlled by a public telephone carrier, such as AT&T, or a public wireless cellular telephone carrier, such as Verizon Wireless. A public telephone carrier is any service provider of telephone service which accepts a contract to provide telephone service (which may include voicemail service) to any member of the public as long as that member provides consideration (e.g., pays service fees) for the service. Similarly, a public wireless telephone carrier is any service provider of a wireless telephone service (such as a CDMA or GSM wireless cellular service or a WiFi or WiMax wireless service) which accepts a contract to provide wireless telephone service (which may include voicemail service) to any member of the public as long as that member provides consideration (e.g., pays service fees) for the service. These carriers operate or control the voicemail servers to record voicemails left for customers of the public telephone carrier or the public wireless cellular telephone carrier. For example, a caller from phone 121 may call the phone number of one or more wireless cellular telephones 123, and if there is no answer, leave a voicemail by causing the voicemail to be recorded on the voicemail server 111 for the user of the one or more wireless cellular telephones 123. Similarly, a caller from the voice over IP phone 117 may leave a message on the voicemail server for a customer of a public telephone carrier, which may be the user of phone 121 or the user of the wireless handheld computer 125 or the user of the wireless cellular telephone 123. In this manner, any one of the telephone devices, such as telephone devices 119, 121, 117, 115, 125, and 123 may leave a voicemail for other telephone device users on one or more voicemail servers, such as the voicemail servers 111. These voicemails may be accessed and listened to by making a conventional telephone call to the voicemail server through a telephone device. As will be described further below, in at least certain embodiments, the voicemails may also be accessed through a data network, such as an HTTP connection through the Internet to the voicemail servers 111.

In at least certain embodiments, a voicemail database may be maintained on a voicemail server and/or a voicemail database may be maintained on a telephone device, such as the data processing system 20 or the data processing system 30 which may be contained within the wireless cellular telephone 123 or the wireless handheld computer 125 of FIG. 3. The database on each system may include an audio file or a pointer to an audio file which provides the voicemail message as well as metadata concerning the voicemail message, such as whether the message has been listened to, whether the message is to be deleted, whether the message has been marked as important or not, etc.

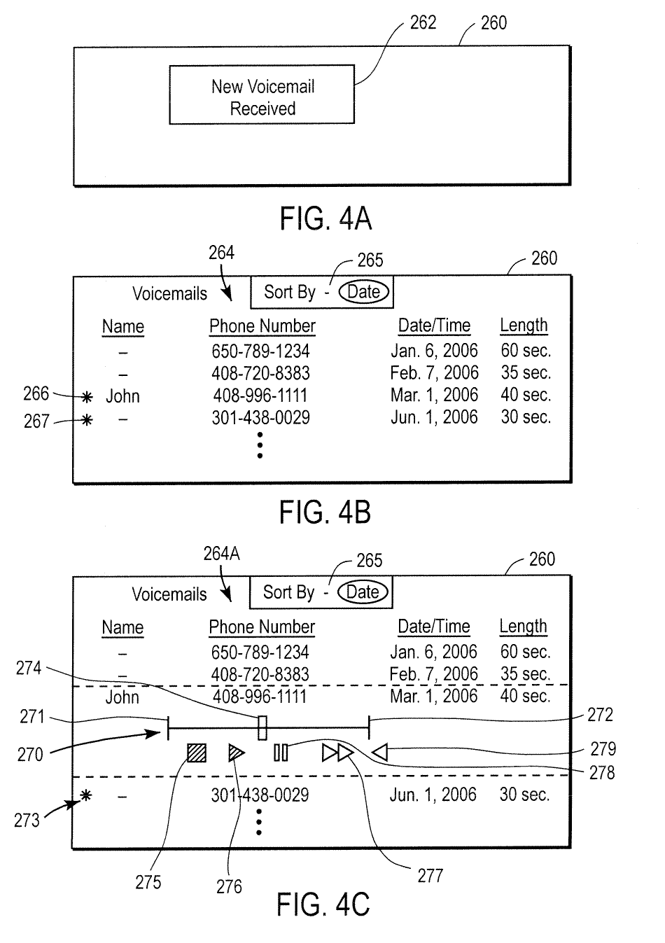

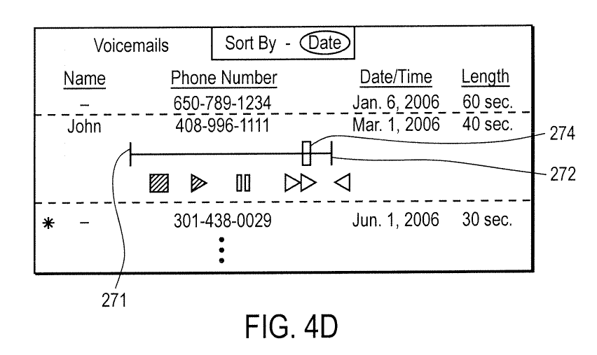

FIGS. 4A-4D reflect the presentation of a user interface on a telephone device for which the voicemail account exists or on other telephone devices, such as any one of the telephone devices shown in FIG. 3, which may include, within any one of those telephone devices, a data processing system such as that shown in FIG. 2B or 2C. The presentation may occur by displaying information on a display device; alternatively, the presentation may occur by providing sounds to a speaker to those who are blind, or other presentations (Braille) etc. The display 260 may be the entire display surface of the telephone device or a portion thereof, such as a window having a border. FIG. 4A shows an example of an alert which may appear in response to a notification of, for example, a new voicemail. Upon seeing the alert 262, the user may select to see the voicemails by issuing a command to the telephone device; alternatively, the system may automatically, after a period of time or otherwise, cause the presentation of a list of voicemails, such as that shown in FIG. 4B which includes the list 264 within the display 260. Each voicemail includes at least some data in fields arranged as columns. One field is a name field which includes at least one name (“John”) in the case of the third voicemail from the top. The other voicemails do not include a name because their phone numbers have not been associated with an entry in a contact or address book (stored at either or both of the telephone device or the voicemail server) which includes names associated with at least certain phone numbers. The phone number column specifies the phone number of the person who left the voicemail. The date/time column represents the date the voicemail was left, and the length column indicates the duration of the voicemail. Other data may also be shown, such as whether or not the voicemail has been listened to. This may be indicated by highlighting those which have been listened to and not highlighting the others, or by providing some other indicator, such as the indicators 266 and 267, which indicate that the third and fourth voicemails have not been listened to but the other two voicemails shown in the list 264 have been listened to. It will be understood that there may be many additional voicemails shown in the list 264, each with pertinent metadata with respect to the voicemail. The voicemails may be sorted by selecting a sort command from the “sort by” menu 265. In the example shown in FIGS. 4B and 4C, the voicemails are sorted by date; alternatively, they may be sorted by name or phone number or by length of time. Other sorting options may also be available depending upon the metadata which is associated with each voicemail (e.g. importance of voicemail as designated by the caller, expiration date, etc.). The user interface shown in FIG. 4B allows a user to browse the list of voicemails and select any one of them for further action or operation. For example, the user may browse the list and decide to listen first to the fourth or tenth voicemail rather than the voicemail at the top of the list, which is the oldest voicemail in this example. In other words, the user is not constrained to listen to the voicemail in the order determined by the recording or receipt of the voicemail by the voicemail server. Rather, the user may randomly select any voicemail in any order such that the series of voicemails selected in a particular order does not have to match the order presented by the voicemail server.

The user interface shown in FIGS. 4B, 4C and 4D may also include user selectable commands or controls to perform operations with respect to the various voicemails. For example, the controls may include commands or controls to delete a voicemail, save a voicemail, forward a voicemail to another telephone number or voicemail server, listen to a voicemail, or move a voicemail to a folder, such as a folder for voicemails from work or voicemails for home, etc. These commands may be presented as menu items on a menu bar or may be accessed from a pull down menu or a pop up menu or other menu structures. The user may be able to select these commands by tapping the commands or pointing a cursor at the commands and pressing a button or by other techniques known in the art.

The interface shown in FIG. 4C occurs or is presented after the user has selected a particular voicemail for playback; in other words, the user in this case has selected the third voicemail from “John” to listen to by playing it back. In response to the selection, the indicator 266 is removed and a time line with playback controls is displayed under the metadata for the voicemail from John. The time line 270 includes a beginning indicator 271 and an ending indicator 272 and includes a current time indicator 274. The term “time line” (such as playback time line) is meant to include any representation, such as a line or a circle or other shape or form which can represent time and allow a user to select a time within a voicemail, at least with some level of granularity in time. The current time indicator indicates the time within the voicemail at the current playback moment. In the particular example shown in FIG. 4C, the current playback time is about halfway through the voicemail as indicated by the current time indicator 274. This current time indicator may merely indicate the time or, in other embodiments, may be user-adjustable in that the user may select the current time indicator and move it left or right to select a different playback time, causing the playback to begin from that time. The user may drag the indicator 274 or may touch or select a new location for the indicator 274, causing it to be re-located to the new location and causing playback to occur from that point, which may be an arbitrarily selected point. Normally, the time indicator moves from left to right beginning from the beginning indicator 271 and ends at the ending indicator 272. Playback controls 275, 276, 277, 278, and 279 allow a user to stop the playback, start the playback, pause the playback, fast forward through the playback, or move in reverse by selecting one of these controls. For example, selecting the stop control 275 will cause the playback to be stopped. Selecting the playback control 276 will cause playing to begin from a currently stopped position. The pause control 278 will pause the voicemail at the current position without resetting the voicemail to the beginning of the voicemail file (thereby causing the current time indicator 274 to move back to the beginning indicator 271). In other words, the pause control 278 merely stops the playback but allows the playback to continue from where it was stopped by selecting the playback control 276. The fast forward control 277 allows the user to move quickly through the voicemail recording to get to a later point. The reverse control 279 allows the user to move in reverse in time through the time sequence of the voicemail. It will be appreciated that in certain embodiments, the time line indicator may be presented by itself without playback controls and yet in other embodiments, only the playback controls may be presented without a time line indicator with its associated control or indicator. In other embodiments, the playback controls and/or the time line indicator may be placed in another location in the user interface rather than adjacent to (e.g. underneath) the voicemail being played back. In addition, other user interface controls may be presented or used such as scrolling or window related commands. The list may be scrollable through the use of a cursor or a stylus or a finger; the scrolling may occur through direct manipulation of the list on a touch input panel, such as a single or multi-touch input panel. The list may be presented in a window which can be minimized or closed or re-sized.

Another aspect of at least certain embodiments is shown in FIG. 4D which illustrates how the user may view and manipulate other voicemails while one voicemail is being played back. In the example shown in FIG. 4D, playback of the third voicemail from John is occurring while a user has selected the second voicemail (from “408-720-8383”) and has caused that voicemail to be deleted. This may occur while the user is listening to the playback of the voicemail from John. In other embodiments, a user may perform other operations with respect to one or more voicemails while listening to another voicemail. FIG. 4D also shows another aspect of the user interface; in particular, a current time indicator 274 has moved closer to the ending indicator 272, indicating that the voicemail from John is nearly completely played back.

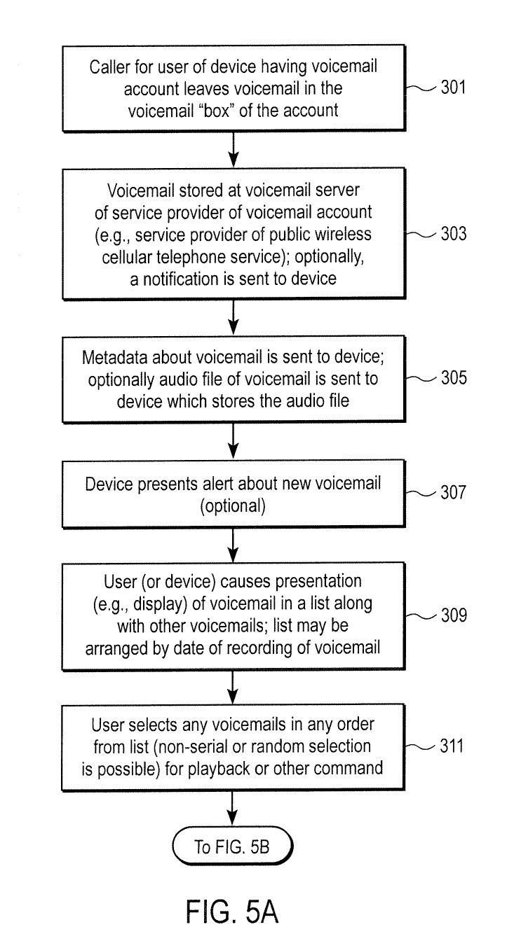

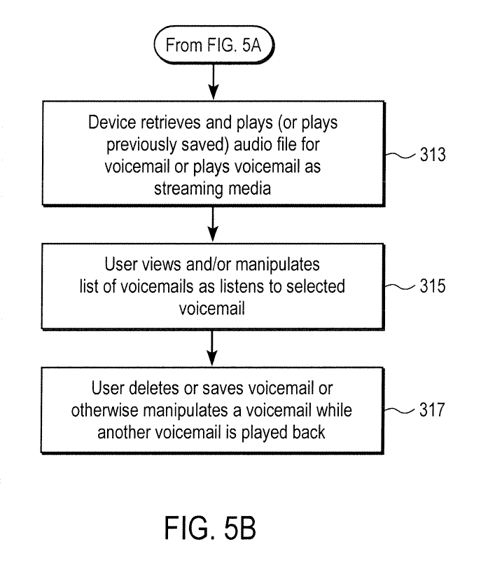

FIGS. 5A and 5B will now be referred to describe an example of how a voicemail user interface may operate. In operation 301, a caller for the user of a telephone or other device having the voicemail account leaves a voicemail in the voicemail mailbox of the account. This voicemail, in operation 303, is stored at a voicemail server of a service provider of the voicemail account. For example, the service provider may be a public wireless cellular telephone carrier and the telephone device may use the telephone service provided by this public wireless cellular telephone carrier. In this embodiment, the voicemail server records voicemails left for the customer of the public telephone carrier. Optionally, a notification may be sent to the device that the voicemails have changed at the server. Metadata about the voicemail is sent in operation 305 to the device. Optionally, the audio file of the voicemail is sent to the device which stores the audio file on the device. The metadata may include the phone number of the caller, optionally the name of the caller (which may be entered through the keypad of the caller or by a lookup operation which compares the caller's phone number to a stored name for that caller). The metadata may also include the length of the voicemail, any markers, such as “urgent” or “special,” the date and time of the voicemail, and the length of the voicemail. In operation 307, the telephone device may present an alert about the new voicemail, such as the alert 262 shown in FIG. 4A. Then the user or the device may cause the presentation of voicemails in a list, such as the list 264. In one embodiment, this list may be arranged by the date of recording of the voicemail as shown in the list 264. Then in operation 311, the user may select any voicemail in any order from the list rather than being required to enter a selection serially beginning from the oldest voicemail to the most recent voicemail. This selection may be a selection for playback or any other command in at least certain embodiments. In the example shown in FIG. 4B, the user may select the fourth voicemail or the tenth voicemail as the first voicemail to be listened to, even though other voicemails which have not been listened to are older, etc. In other words, the user is not constrained by the order of recording of the voicemails. This user interface may be implemented on a display such as that shown in FIG. 2D or the display 7 shown in FIG. 2E or the display 93 and/or the display 88 shown in FIGS. 2F and 2G, respectively. In response to the selection in operation 311, the system retrieves and plays or plays the previously stored audio file for the voicemail which has been selected in operation 313. Alternatively, the telephone device may play the voicemail as a streaming media or download portions of the voicemail for playback as described elsewhere herein. As shown in operation 315, the telephone device may allow a user to view and/or manipulate one or more voicemails in the list of voicemails as the user listens to the voicemail which was selected in operation 311. The manipulation described in operation 315 may occur in operation 317 in which a user deletes or saves a voicemail or otherwise manipulates a voicemail while another voicemail is being played back.

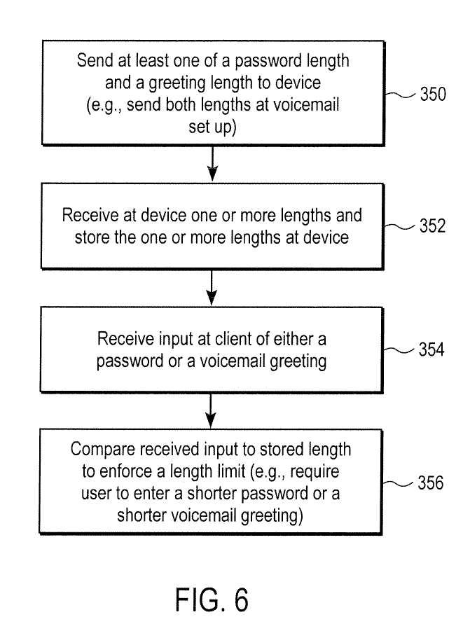

FIG. 6 shows another aspect of certain embodiments of the inventions. The method shown in FIG. 6 shows how a client device can locally enforce a voicemail parameter without having to receive additional information from a voicemail server. The voicemail parameter may be the length of a voicemail greeting or the length of a password or another parameter. In operation 350, at least one of a password length and/or a greeting length is sent to the device; this would typically occur upon the initialization of a voicemail account. In other words, when the voicemail account is initially being set up, the transmission of these lengths would typically occur at that time. The device in operation 352 receives the one or more lengths and stores them for future use at the device. In operation 354, the device receives either a password, such as a new password or a changed password, or a new greeting or a changed greeting. In response to operation 354, the system compares, in operation 356, the received input to the stored data to enforce the voicemail parameter. In the case of a password length, the system compares the length of the password inputted in operation 354 to the length stored for a password which is valid. This length may be specified as two lengths which include a minimum length and a maximum length, although in certain embodiments, it may be one length which is merely the minimum length or the maximum length. In another embodiment, the length may specify the length of a voicemail greeting in seconds, for example. Hence, in this case, operation 356 would compare the length of a new or changed voicemail greeting to the limit in time for a voicemail greeting transmitted in operation 350. This allows the client device to locally enforce the parameter without requiring that the new or changed password or new or changed greeting be transmitted to a voicemail server or some other voicemail system within the infrastructure and rejected, causing a rejection message to be sent back to the client device. In other words, network traffic can be reduced by locally enforcing the voicemail parameter at the client device.

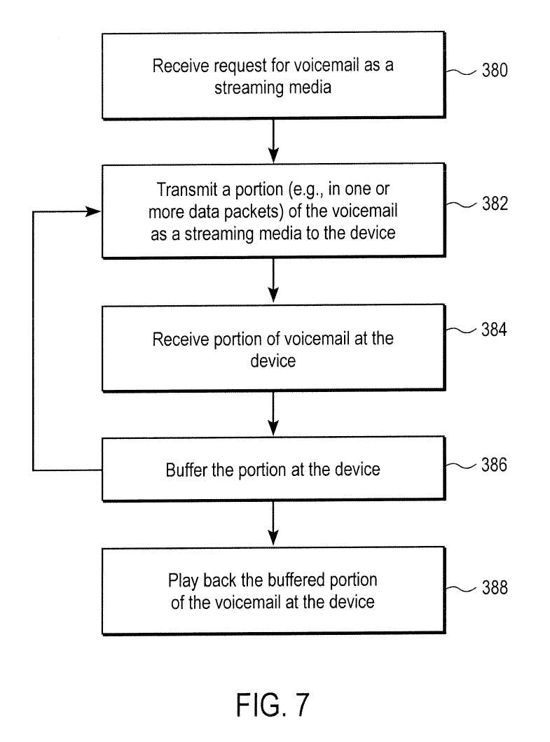

FIG. 7 shows another aspect of at least certain embodiments of the present inventions. The method of FIG. 7 relates to the streaming of voicemails from a voicemail server or other server to the client device, which may be any one of the telephone devices shown in FIG. 3 and which may include the data processing system, such as the system 20 or 30 shown in FIGS. 2A and 2B, respectively. In operation 380, a system within the infrastructure receives a request for a voicemail as a streaming media. The system may be a voicemail server, such as the voicemail server 111 shown in FIG. 3. In response, the system transmits a portion, in operation 382, of the voicemail as streaming media to the device. The portion may be transmitted as one or more data packets, each having a header which specify a time or frame number or multiple times or multiple frame numbers associated with the portion relative to the entire voicemail. In operation 384, this portion of the voicemail is received at the device, and this portion is buffered in operation 386. The transmission, receipt and buffering in operations 382, 384, and 386 are typically repeated several times. The portions are buffered as they are received and the transmission typically continues while the receipt and the buffering continues. In a typical streaming operation, playback in operation 388 occurs after a sufficient quantity of data has been buffered from operation 386. The playback occurs by retrieving data from the buffer as it is also being filled by new data from operation 384. The playback of a received portion of the voicemail in the streaming media can occur as later portions in the streaming media are being received and buffered. In this manner, at least some voicemails can be retrieved by using a streaming media technique rather than downloading the file and saving it locally on the telephone device.

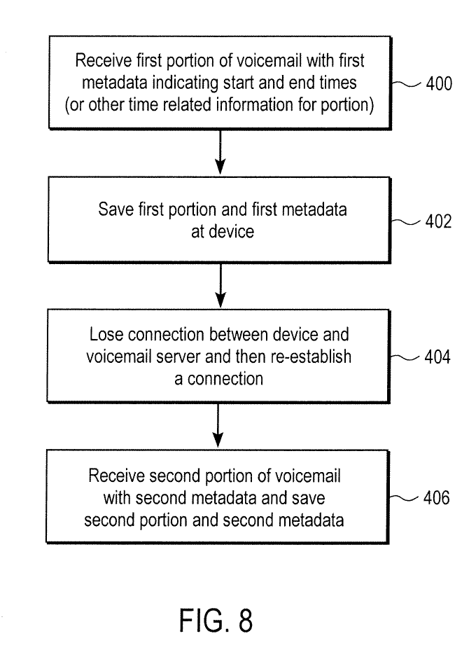

FIG. 8 shows a method according to another aspect of at least certain embodiments of the inventions. The method of FIG. 8 does not utilize a streaming media technique but rather uses a partial download technique to download portions of the voicemail along with identifiers which indicate how the portion fits within the entire time sequence of a voicemail. These identifiers may be time based positions in a file or a byte based position, such as a data range, in a voicemail audio file. In operation 400, a telephone device, which may be any one of the telephone devices shown in FIG. 3 and which may include the systems 20 or 30 shown in FIGS. 2A and 2B, respectively, may receive a first portion of a voicemail with first metadata indicating start and end times or other time related information for that portion relative to the entire voicemail time sequence. This information is saved in operation 402. If the telephone device is coupled to the voicemail server through the wireless telephone connection, it is possible that the connection could be lost, as shown in operation 404, and then reestablished. It will be understood that operation 404 is optional and that the second portion may be received from operation 406 without having lost the connection. The second portion of voicemail data also includes second metadata which specifies a time relationship of the second portion relative to the entire time sequence of the voicemail. The partial downloading of voicemails with this metadata allows for downloading of voicemail audio files or other voicemail information even in wireless cellular networks which may have sporadic coverage. The playback of a received portion (e.g. first portion) can occur before or while receiving another portion of the voicemail.

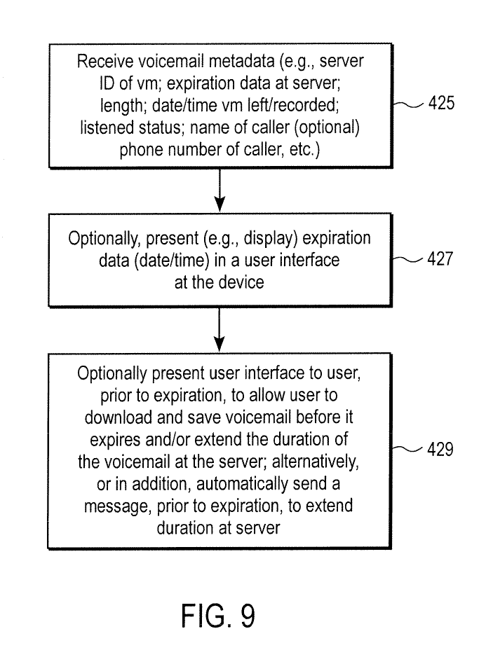

FIG. 9 shows a method which may be used in at least certain embodiments of the present inventions. This method utilizes an expiration date for a particular voicemail in order to provide a way for a user to be notified of or to otherwise take an action with respect to, either through user interaction or by the system automatically, a voicemail before it expires. This allows the system to prevent a voicemail from being accidentally deleted or erased should its expiration date pass. In operation 425, a voicemail metadata is received at a telephone device, such as any one of the telephone devices shown in FIG. 3 which may include a data processing system 20 or 30 shown in FIGS. 2A and 2B, respectively. The voicemail metadata may include the server ID number, which is typically a unique ID number, assigned by a voicemail server, for each voicemail for a particular voicemail account, the expiration date of that voicemail, the length of the voicemail, the date and time that the voicemail was left or recorded, the status of the voicemail, the name of the caller, which is optional, and the phone number of the caller, if available, etc. The expiration data, which may be part of this metadata, is typically provided as a day and time, although it may be merely a day if a standardized time for deletion is established in the system. In operation 427, the expiration date or data may optionally be presented to a user in a user interface. This may occur when it is about to be deleted or at a time before deletion or in any presentation of a list of voicemails. For example, the user interface shown in FIG. 4B may include the expiration data. In certain embodiments, the expiration data may be displayed in a column and the list of voicemails may be sorted by expiration date. In addition to or as an alternative to the mere presentation of the expiration data for a particular voicemail, the system may also perform operation 429. In operation 429, an optional user interface may be presented to the user prior to expiration to allow a user to download and/or save the voicemail before it is erased. Alternatively, the user interface may give the user the ability to send the command to a voicemail server to extend the duration date of the voicemail at the server. In one embodiment, this user interface may be presented at either a predefined or dynamically generated time or at another time prior to expiration of the particular voicemail. Alternatively, or in addition, a message may be sent automatically to the voicemail server prior to expiration of the voicemail to extend the duration at the server or to cause the voicemail to be downloaded to the telephone device. It will be understood that the expiration data for a voicemail is for that particular voicemail and another voicemail will typically have a different expiration date depending upon the policies and rules of a voicemail system.

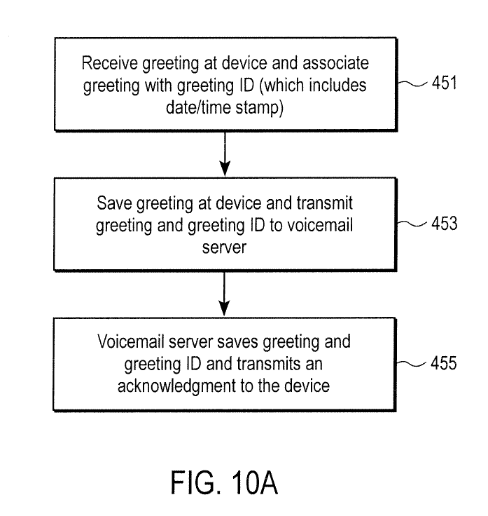

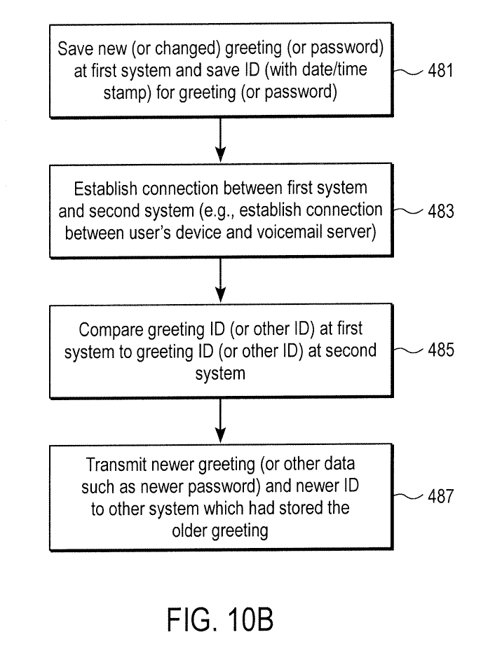

FIGS. 10A and 10B relate to another aspect of certain embodiments described herein. At least certain embodiments allow a user to set up a greeting or to change a greeting by at least two different mechanisms. For example, after initialization of a voicemail system, a user may be able to change the voicemail greeting at a telephone device which is the device for which the voicemail account has been established, or at a land line telephone or other phone having a phone number for which the voicemail account was not established. Either of such telephones could be used to call the voicemail server to change the greeting message in the voicemail system. Being able to change the voicemail greeting from a plurality of different devices may cause confusion in that a greeting stored at a telephone device for which the voicemail account has been established may be different than the voicemail greeting saved at a voicemail server. For example, if the original voicemail greeting was recorded at the telephone device for which the voicemail account exists and this telephone device saves a cached version of this original voicemail greeting, and then the user changed the greeting by using a different telephone device (having a phone number for which there is no voicemail account) then there are two different voicemail greetings which are stored on the two different systems. It is useful to have a way to distinguish between those greetings to determine which one is the newer greeting, as it is assumed that the newer greeting reflects the intent of the user of the voicemail account.

FIG. 10A shows a process for initializing the voicemail greeting. In operation 451, the greeting is received at the device, and a greeting ID is associated with the greeting. This greeting ID may include a date and time stamp along with the phone number of the telephone device which owns the voicemail account. This greeting is saved at the telephone device and transmitted to a voicemail server. In another embodiment, the server may generate the greeting ID and save it at the server and transmit the greeting ID, assigned at the server, to the telephone device. Also, the greeting identifier (ID) is also transmitted to the voicemail server. The voicemail server, in operation 455, saves the greeting and saves the greeting ID and transmits an acknowledgement to the device. The transaction, in operation 455, may advantageously be an atomic transaction using techniques known in the art to create an atomic transaction when saving data. After initialization, the method of FIG. 10B may be employed to determine which of two saved greetings is the most current greeting which should be used on both devices. In operation 481, a new or changed greeting is saved at a first system. In an alternative embodiment, a new password may be saved at the first system. In addition, in operation 481, a unique identifier is also saved for the greeting or password. This identifier may include the telephone number of the telephone device which owns the voicemail account and may include a date and time stamp. Operation 481 may occur when the first system is not in communication with the second system. For example, operation 481 may occur when the telephone device, which owns the voicemail account, is not connected to a voicemail server. It will be understood that the first system may be either of the telephone device or the voicemail server. In operation 483, a connection is established between the first system and the second system. For example, a connection may be established between the user's telephone device, which may be any one of the telephone devices shown in FIG. 3, and the voicemail server. Then in operation 485, the identifier, such as a greeting identifier, at the first system is compared to the greeting identifier at the second system. If these identifiers match, then it shows that the two systems are synchronized with respect to the greeting. If they do not match, then the more recent greeting identifier is determined to be the correct identifier and its associated greeting is transmitted in operation 487 to the other system which has the older greeting (or older password). In addition, the identifier for the newer greeting or newer password is also transmitted to the other system which had stored the older greeting or older password. Atomic transactions, which are known in the art, may be preferred to save the greeting and/or greeting ID to make sure the transaction is completed entirely or not. By implementing the methods of FIGS. 10A and 10B, it is possible for a user to change a greeting or a password at any telephone device which can connect to a voicemail server or other voicemail infrastructure system rather than being required to change the greeting or password using only the device which owns the voicemail account (e.g. the device which initialized the account).

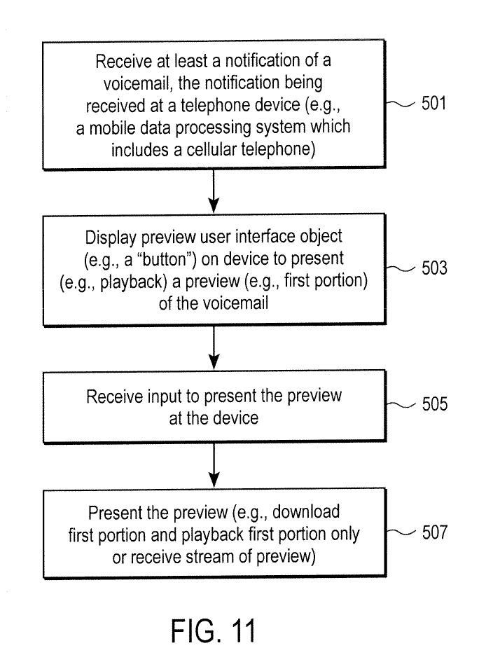

FIG. 11 relates to another aspect of at least certain embodiments of the inventions. This aspect allows a preview, which is only a portion of a voicemail, to be presented on a telephone device. The portion may, for example, be a first portion in time of the voicemail such as the first 10 seconds or 20 seconds of the voicemail. In operation 501, a telephone device (e.g., any one of the telephone devices in FIG. 3) receives at least a notification of a voicemail; the notification may include information specifying the voicemail (e.g., metadata for the voicemail) or merely that there is a new voicemail. In response to the notification, the telephone device may download the content of the voicemail or may download only a portion (e.g., a preview) of the voicemail or may prepare to establish a streaming media connection to obtain a stream of the voicemail or may download metadata for the voicemail. In operation 503, the telephone device may present (e.g., display) a preview user interface (UI) object, such as a button, on the telephone device; this preview UI object may be an icon displayed next to a representation or presentation of metadata for the voicemail. If this icon is selected (for example, by pressing or pointing at or “clicking” the button), the preview is presented. In operation 505, the telephone device receives an input to present the preview at the telephone device; this input may be the selection of the icon or any other input received relative to the preview UI object. In response to the input in operation 505, the telephone device, in operation 507, presents the preview. If the voicemail is longer, in duration, than the preview, the presentation (e.g., playback) of the voicemail will end at the end of the preview; for example, if the preview is 15 seconds and the voicemail is 45 seconds long, only the first 15 seconds are played back. The presentation may involve downloading all or only a portion (the preview portion) of the voicemail or may involve receiving a stream of the preview. In addition to presenting, the preview UI object, the telephone device may also concurrently present another UI object, such as a playback button, which, if selected, will cause the playback or presentation of the entire voicemail (or the presentation of the voicemail until a user selects a stop or pause UI object, such as a stop or pause button).

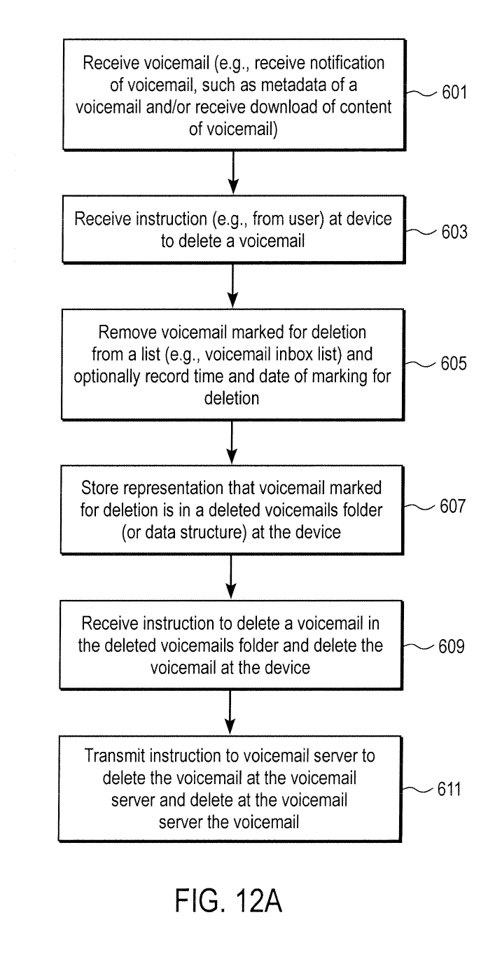

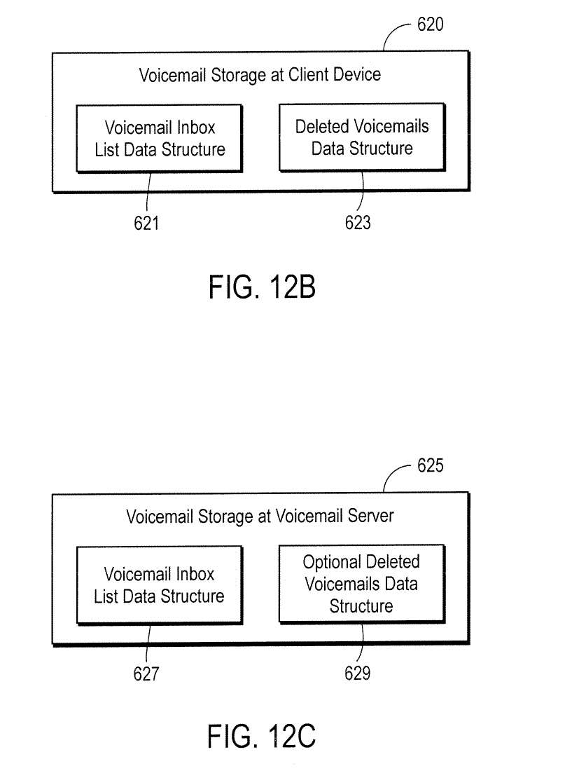

Certain embodiments of the inventions relate to techniques for managing deleted voicemails. For example, FIGS. 12A, 12B, and 12C depict one method of maintaining a data structure for voicemails which have been marked for deletion but are not yet deleted. This data structure may resemble a container or folder which stores or is otherwise associated with voicemails which have been marked for deletion. This data structure may be maintained at a client data processing system, such as a mobile data processing system which includes a wireless cellular telephone, or in a server system, such as a voicemail server system, or both. FIG. 12B shows an example of a memory structure (e.g. DRAM or flash memory or magnetic media memory, etc.) at a client device, such as a mobile data processing system, which includes a wireless cellular telephone which may be used to store a data structure for deleted voicemails as well as a data structure for voicemails currently in the inbox of the voicemail mailbox. FIG. 12C shows an example of a storage medium for a voicemail server which may include storage for an optional deleted voicemail data structure as well as the inbox of the voicemail for one or more users. Further details with respect to these storage media in FIGS. 12B and 12C are provided further below.

Reference is now made to the flow chart of FIG. 12A which shows an example of a method for maintaining a data structure for voicemails which are marked for deletion but are not yet deleted until further action is taken. It will be appreciated that the data structure may take a variety of different forms, such as a container or folder, or a list with a field which indicates whether a voicemail is marked as deleted or not. It will also be understood that, at least initially, the voicemail is merely marked for deletion rather than actually deleted as explained further below. The marking may be made by a flag or other indicator that the voicemail is to be deleted; this may occur by moving the voicemail from the voicemail inbox to a delete folder or trash folder for voicemails which are to be deleted from the delete folder or trash folder at some point in the future, either manually by the user or automatically by the system.

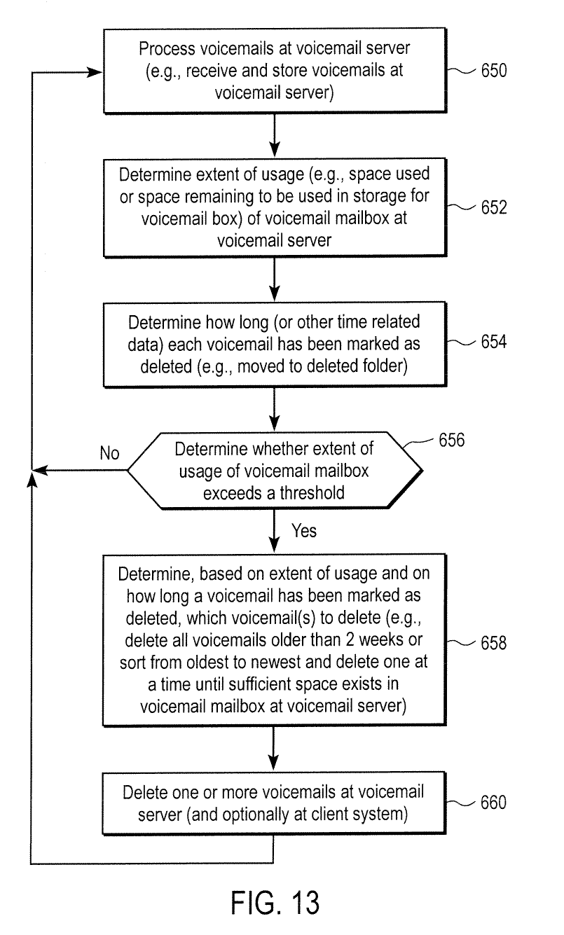

The method shown in FIG. 12A may begin in operation 601 in which a voicemail is received. This may involve receiving a notification of a voicemail, such as metadata for the voicemail, or may involve receiving, through a download process, the actual content of a voicemail (e.g. an audio file containing the recorded voice of a caller to the voicemail mailbox). The metadata of a voicemail may include information identifying the caller by name, the phone number of the caller, the length of the message, and other information. In operation 603, a device, such as a mobile data processing system which includes a wireless cellular telephone, may receive an instruction, such as an instruction from the user to delete a voicemail. This may occur either after listening to the voicemail or before listening to the voicemail. In this embodiment, operation 605 responds to the instruction by removing the voicemail which has been marked for deletion from a list, such as a list of voicemails in the inbox for voicemails. Further, this operation may optionally record the time and date of marking for deletion, which may be used in the embodiments described further below, such as the embodiments relating to FIGS. 13-15C. In operation 607, a system stores a representation (e.g. a flag is set) that the voicemail marked for deletion is a deleted voicemail, which representation includes some data in a data structure that represents the fact that the voicemail has been marked for deletion. This data structure may exist at a client data processing device, such as a mobile data processing system which includes a wireless cellular telephone. These operations 605 and 607 may also include creating a copy of the voicemail and placing or associating the copy with a deleted voicemails folder and deleting the voicemail from an inbox folder after the copy is created. In operation 609, an instruction is received to delete a voicemail in the deleted voicemails folder and, in response, the system at the client data processing system deletes the voicemail. In operation 611, an instruction is transmitted to a voicemail server to cause the deletion of the voicemail at the voicemail server. It will be understood that the operations of FIG. 12A may be performed in a different sequence in certain embodiments and more or fewer operations may be included in alternative embodiments.

The method of FIG. 12A causes the creation of a data structure for deleted voicemails or voicemails which have been marked for deletion but have not yet been deleted. This data structure may be formed at a client device, such as a mobile data processing system which is the client of a voicemail server. This data structure may be alterable by the user such that, for example, a user may remove a voicemail from the deleted folder or container; this effectively unmarks the voicemail, allowing the user to listen to the voicemail previously marked for deletion. In one embodiment, a copy of the voicemail which is removed from the deleted folder is copied to an inbox folder and the copy of the voicemail in the deleted folder is expunged. The user may be required to unmark the voicemail or remove it from the delete folder in order to listen to (or take other actions such as forward or save) the voicemail. An example of this data structure is shown as data structure 623 in the storage device 620 of a client device, which also includes a data structure for voicemails in an inbox for a user of the client device. This data structure may be a list data structure such as the list data structure 621 shown in FIG. 12B. When a voicemail in the inbox list data structure 621 is marked for deletion, it may be considered moved or associated with the deleted voicemail's data structure 623. Operation 605 is an example of removing a voicemail marked for deletion from the data structure 621 and placing it in the data structure 623. In other embodiments, there may be a single data structure which includes both voicemails in an inbox and voicemails marked for deletion which may be shown in a single list or other format. However, even in this case, a portion of that data structure may be considered to be a data structure which designates deleted voicemails (marked for deletion but not yet deleted) by some identifier, such as a flag or other indicator.

A voicemail server may also maintain a data structure for voicemails which have been marked for deletion (but are not yet deleted), such as the data structure 629 shown in the storage 625 for a voicemail server. This storage may also include a list data structure 627 which includes voicemails in the inbox of the voicemail mailbox of a particular user or set of users.

In certain embodiments, the method of FIG. 12A allows a user to mark a voicemail for deletion and thereby remove the voicemail from a list of voicemails in the inbox of the voicemail mailbox of a user, but still be able to retrieve and listen to and otherwise use (e.g. save or forward) the voicemail before it is actually deleted. This allows, for example, the user to retrieve an accidentally deleted voicemail or to decide to, in effect, undelete a voicemail which was intentionally deleted. Since the marking for deletion in operation 605 is performed before the actual deletion in operation 611, the voicemail which has been marked for deletion may be used well after the time on which it was marked for deletion. This may allow, for example, a user to store a voicemail in the deleted folder for later retrieval and usage, such as listening to or saving or forwarding the voicemail. When the voicemail is deleted in operation 609 and 611, it may be deleted from both the voicemail server in operation 611 and the client device 609. This deletion may involve deleting the content of the voicemail as well as metadata for the voicemail. The fact that the voicemail may be retained for a considerable period of time may pose a problem for storage constraints at a voicemail server; the several following embodiments employ one technique for dealing with storage constraints at a voicemail server or other systems.

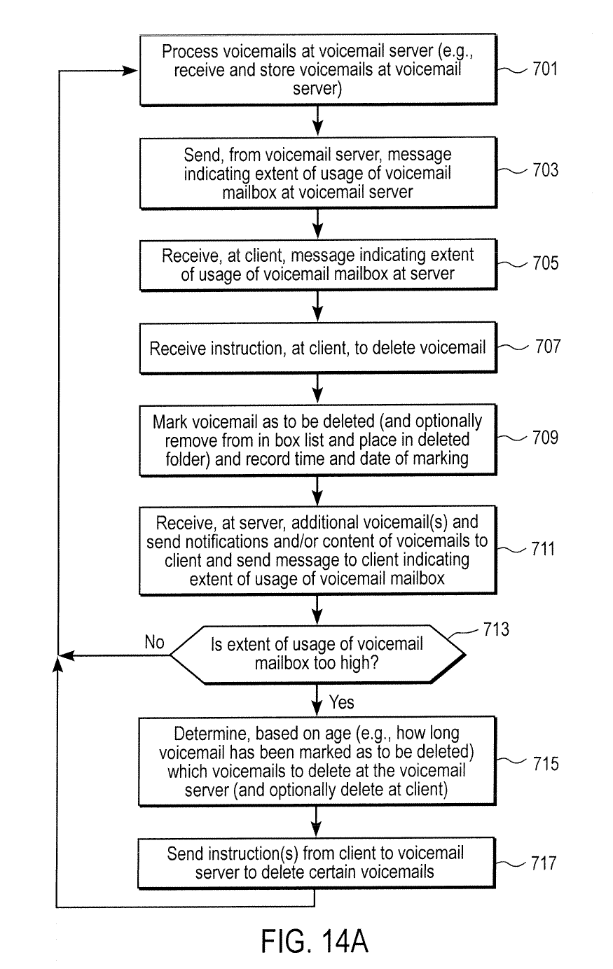

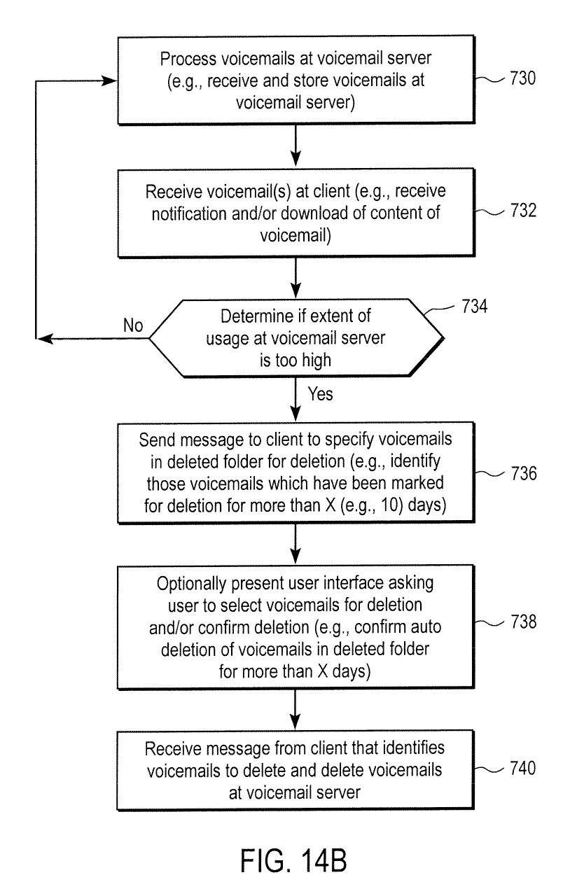

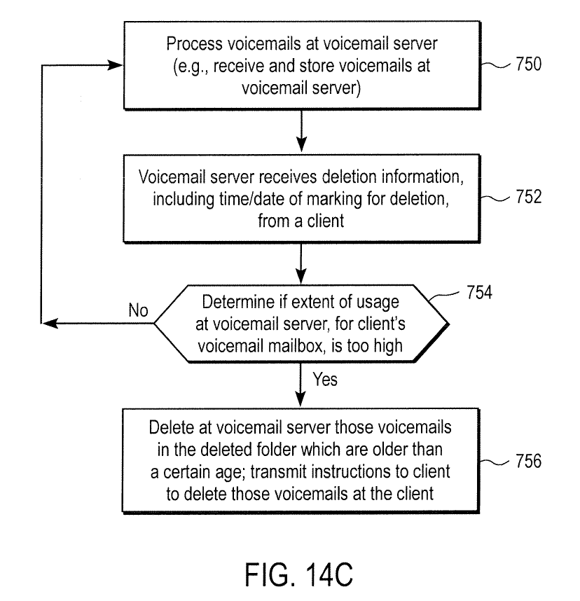

The embodiments shown in FIGS. 13-15C relate to the use of time data and usage data to select voicemails for deletion and to also delete voicemails. These deletion operations may be performed automatically without user input or with some presentation of information to the user about the deletion or requiring consent of the user in certain cases. The information which is utilized in the process of determining which voicemails to delete may be kept at one or both of a client or server system and either system may make the decision, depending on the particular embodiment. For example, all the necessary information may be supplied to a client device which makes the decision in certain embodiments; in alternative embodiments, information is supplied to the voicemail server which may make the decision. The decision and the deletion may occur automatically without any user input or may require user input to acknowledge the deletion, which acknowledgement or input may allow the user to select different voicemails to be deleted in order to comply with the requirement to limit the size of a voicemail mailbox to a certain size. It will be understood that the various methods shown in FIGS. 13-14C may, in alternative embodiments, include operations which are performed in a different sequence and may include more operations or fewer operations than those shown in these figures.

FIG. 13 represents a general example of a method which utilizes time related data and data relating to the extent of usage of a voicemail mailbox at a voicemail server in order to determine which voicemails to delete in the voicemail mailbox. The time related data may be considered to be aged data which specifies how long each voicemail has been marked for deletion, such as how long each voicemail has been moved to a delete folder on a client data processing system as described in FIG. 12A.

The method shown in FIG. 13 may begin in operations 650 in which voicemails are processed at a voicemail server. This may include receiving and storing voicemails at a voicemail server for one or more voicemail mailboxes. The receiving and storing of the voicemails may occur as a result of the caller leaving a voicemail for the owner or user of a voicemail mailbox. In operation 652, the voicemail server or another system may determine the extent of usage remaining to be used in storage for a voicemail mailbox. This may be represented as the space used or the space remaining to be used in the storage for the voicemail mailbox. In operation 654, it is determined how long each voicemail has been marked as deleted, such as the marking which results from receiving the instruction in operation 603 of FIG. 12A. The length of time determined in operation 654 may be measured in days or weeks or other time increments. Further, this operation may be performed by a client data processing system which transmits this information to a server so that the server can make a decision of whether or not to delete voicemails or it may remain at the client system so that the client system can make that decision. In operation 656, it is determined whether the extent of usage exceeds a threshold. If it does not, processing returns to operation 650; if it does exceed the threshold, then processing proceeds to operation 658 in which it is determined, based on the extent of usage and how long a voicemail has been marked as deleted (but not yet deleted), which voicemails to delete. For example, all voicemails which have been marked as deleted for more than two weeks in a deleted folder may be automatically deleted or the voicemails in the deleted folder may be sorted from oldest to newest and all of the oldest voicemails may be deleted until sufficient storage is recovered at the voicemail server. After determining which voicemails to delete, operation 660 deletes one or more voicemails at the server and optionally at the client system if the client system downloaded voicemails or maintains metadata for the voicemails at the client system. As noted above, this method may be performed at either a client device or the voicemail server or a combination of the systems. Further, the information, such as the age information or the extent of usage information, may be retained at one or both of the systems and used at the systems in order to make a decision. It will be appreciated that the data may be stored at the voicemail server or at a remote storage which is coupled to the voicemail server. In either case, the storage of the data may be considered accessible to the voicemail server and otherwise at the voicemail server. The time related data from operation 654 indicates when a voicemail has been marked as deleted, which is similar to operation 603 wherein the voicemail is indicated to be deleted but is not in fact deleted from the voicemail server until a further instruction is received to cause the deletion of the voicemail. The criteria used to determine whether to delete a voicemail may change as a function of a change of the extent of usage (e.g., in operation 656); for example, the criteria may be more stringent (and hence fewer deletions are done) at low extents of usage (e.g., 10%) and may become more liberal (and hence more deletions occur) at higher levels of usage (e.g., 80% of storage capacity of a voicemail mailbox at the server is used up).

The method shown in FIG. 14A represents an embodiment in which the decision to delete a voicemail is performed at a client system rather than a voicemail server or some other server system in the infrastructure of a wireless cellular telephone carrier or other provider of the voicemail service. In operation 701, voicemails are processed at the voicemail server as is known in the art. This may include receiving and storing voicemails at the voicemail server as is known in the art. In operation 703, a message indicating the extent of usage of a voicemail mailbox is sent from the voicemail server to the client device. This message indicates the extent of usage of the voicemail mailbox at the voicemail server. It may be indicated in a number of different ways, including as a percentage of the available space in the voicemail mailbox or an absolute number indicating the amount of space available or used, or it may be a binary value indicating that the usage exceeds or does not exceed a threshold. The client system, in operation 705, receives the message indicating the extent of usage. This message may be stored at the client system for future use in deciding whether or not to delete certain voicemails. Then in operation 707, the client system may receive an instruction to delete a particular voicemail; this instruction effectively marks the voicemail for deletion but does not cause the voicemail to be deleted, and hence it is similar to operation 603 shown in FIG. 12A. Consequently, in operation 709, the voicemail is marked as to be deleted and the client system records the time and date of the marking. Optionally, the voicemail may be removed from an inbox list and placed in a deleted folder or some other container or data structure which indicates that it is to be deleted and has been marked to be deleted. In operation 711, additional voicemails may be received at the server and notifications of those voicemails and/or content of those voicemails may be transmitted to the client, and further messages indicating the extent of usage of a voicemail mailbox at the voicemail server may be transmitted to the client. In operation 713, the extent of usage of the voicemail mailbox is determined. This may be determined based upon a threshold or a message from the voicemail server indicating that the amount of usage is too high, or other approaches. If the extent of usage is not too high, processing returns back to operation 701. On the other hand, if the extent of usage is too high (e.g. the extent exceeds a threshold) then processing proceeds to operation 715 in which it is determined, based on the age which indicates how long a voicemail has been marked to be deleted, which voicemails to delete at the voicemail server and optionally also to delete at the client system. Then in operation 717, an instruction is sent from the client to the voicemail server to delete certain voicemails which have been selected or determined to be deleted based upon the processing of operation 715.

The method shown in FIG. 14B does not require that the extent of usage at a voicemail server be transmitted to a client device. In this method, a voicemail server requests the client device to specify voicemails in the deleted folder (e.g., specifying voicemails which have been marked for deletion but have not yet been deleted), and then the voicemail server determines which voicemails to delete and returns a message to the client device indicating the voicemails to delete which have been stored at the client device, such as the storage of metadata and/or content of those voicemails to be deleted. In operation 730, voicemails are processed at the voicemail server in a conventional manner, such as receiving and storing voicemails at the voicemail server. In operation 732, one or more voicemails are received at a client device; this may involve receiving a notification which includes metadata of the one or more voicemails and may further include a downloading of the content of the one or more voicemails. In operation 734, the voicemail server determines if the extent of usage for the voicemail mailbox is too high at the voicemail server. If it is not, processing returns to operation 730; if it is too high, then processing proceeds to operation 736, in which a message is sent to the client device to specify voicemails in the deleted folder at the client device for deletion. This message is typically sent from the voicemail server to the client device. The client device may specify voicemails which have been marked for deletion for more than a certain number of days or other period of time or may provide a sorted list of the voicemails in the deletion folder, which list may be sorted by how long each voicemail has been marked for deletion or has been otherwise associated with the delete or trash folder at the client device. An optional user interface may be presented to the user in operation 738. In this operation, the user interface may ask the user to select voicemails for deletion and/or confirm deletion. For example, the user may be presented with a user interface which allows the user to select one or more voicemails in the delete folder or within the inbox in order to reduce the storage usage of voicemails stored at the voicemail server. In other embodiments, the user interface may merely request the user to confirm automatic deletion of voicemails in the deleted folder which are older than a certain number of days or other period of time. Operation 740 may follow operation 738, and in operation 740 a message is received from the client device that indicates or identifies voicemails to be deleted and those voicemails are thereafter deleted at the voicemail server. Optionally, the voicemails, including metadata and/or content of those voicemails, may also be deleted at the client device.

FIG. 14C shows an example of another embodiment in which the extent of usage at a voicemail server and the age of voicemails in a deleted folder may be used to delete voicemails from the deleted folder. In this example, a voicemail server or other system in the infrastructure of a telephone system makes the determination of whether and what to delete rather than having a client device make this determination. In operation 750 of FIG. 14C, the voicemail server processes voicemails in a conventional manner; this may include receiving and storing voicemails at the voicemail server. In operation 752, the voicemail server receives deletion information which may include the time and date of marking for deletion at a client device, such as a mobile data processing system which includes a wireless cellular telephone. The voicemail server is storing voicemails for the client device and also stores this deletion information for future use in operation 756 as explained further below. In operation 754, the voicemail server determines if the extent of usage at the voicemail server for the client device's voicemail mailbox is too high. If it is not too high (e.g. it does not exceed a predetermined threshold) then processing returns to operation 750. If, on the other hand, the extent of usage is too high, then processing proceeds to operation 756; in that operation, the voicemail server deletes those voicemails in the deleted folder which are older than a certain age, wherein the age is measured based upon how long each voicemail is marked to be deleted or is otherwise associated with or contained in the deleted folder. The voicemail server may transmit instructions to the client device to cause the client device to delete those voicemails from the client device, which may include the deletion of metadata for those voicemails and/or the content of those voicemails.

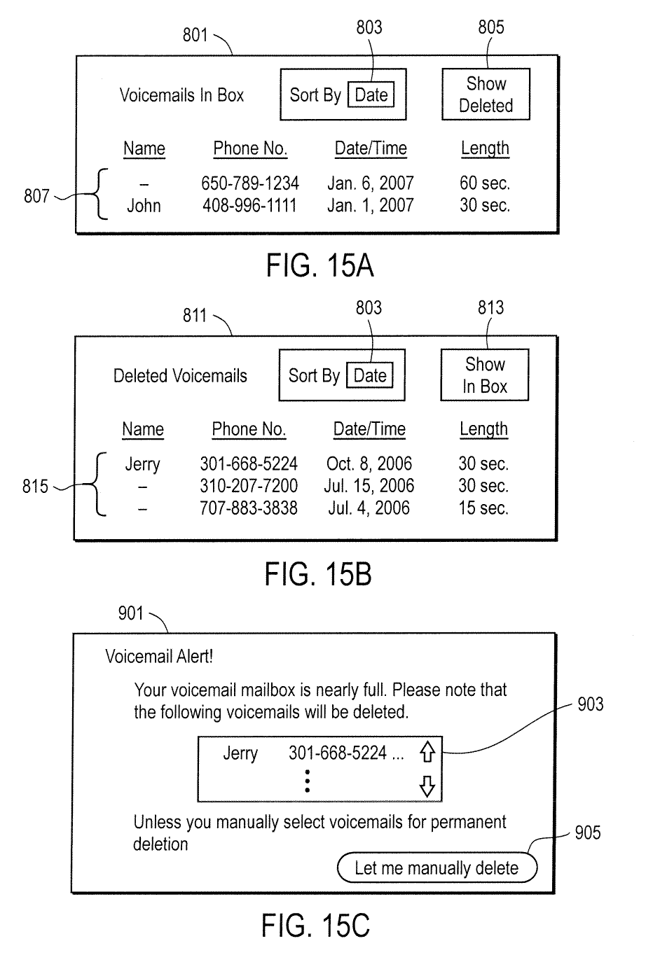

FIGS. 15A, 15B and 15C show examples of user interfaces which may be displayed or otherwise presented to a user of a client device, such as a mobile data processing system which includes a wireless cellular telephone. The user interface of FIG. 15A includes a window 801 which may be displayed on a display device of a mobile data processing system. Within that window, a list 807 of voicemails in the user's voicemail mailbox is shown. The list of voicemails may be sorted by date or by other parameters by selecting the command 803 which may be a pull-down menu or a pop-up menu or other menu structure. In this list, the metadata for the voicemail includes the name of the caller, the phone number of the caller, the time and date of the call, and the length of the call. The user may switch to show the voicemails in a deleted or trash folder by selecting the button or user interface object 805 shown in FIG. 15A. This will, in turn, cause the appearance of the window 811 which is shown in FIG. 15B, which presents a list 815 of deleted voicemails which have been moved or otherwise associated with a deleted voicemails container, such as a deleted voicemails folder. These voicemails may also be sorted by date or other parameter by using the menu 803. The user may switch back to the voicemail inbox shown in FIG. 15A by selecting the button or user interface object 813 shown in FIG. 15B.

FIG. 15C shows an example of a user interface which warns the user that the voicemail system is about to delete certain voicemails which are present in the user's deleted voicemails folder, such as the folder represented in the user interface window 811 shown in FIG. 15B. The window 901 includes information telling the user about the impending deletion and showing the user in the scrollable window 903 the voicemails which are about to be deleted. This particular user interface provides a selectable user interface object 905, which may be a button, which allows the user to manually delete voicemails by selecting the voicemails either in the deleted voicemail folder in the inbox or in other folders or merely in the deleted voicemails folder.

Another aspect of at least certain embodiments of the invention relates to multiple connections to a voicemail server. In this method, a voicemail server may have a constrained number of connections which it can support for a particular telephone device. This may be a rule or policy enforced by a public telephone carrier for a variety of reasons. A method for operating within such a constrained system may involve receiving a selection for playback of a voicemail, and in response to receiving this selection, a connection for this first voicemail is established. This connection may be an HTTP connection through the Internet. The connection may be to download or to stream the first voicemail. In response to the selection, the playback of the first voicemail occurs. In addition, a user interface may present a list of other voicemails, allowing the user to browse and/or manipulate voicemails in the list in the user interface. While playing back the first voicemail, the system may receive a selection for playback of a second voicemail. In response to this selection, the system terminates the first connection and establishes a second connection, such as a second HTTP connection with the voicemail server to download or stream the second voicemail. In this case, the first connection is preempted in order to establish the second connection to playback or otherwise manipulate or access the second voicemail.

Another aspect of at least certain embodiments relates to a method for providing an address or a URL of the voicemail server to a telephone device when it is not initialized. In one embodiment, the telephone device can request the public telephone carrier which provides telephone service for the telephone device to send a SMS message to the telephone device which includes the URL of the voicemail server to allow initialization of the voicemail service. In this manner, the telephone device can be manufactured without having to store a particular URL for a voicemail server. Further, the device can be deployed for a customer without having to store that URL in the device. This also allows flexibility for a service provider, such as a public telephone carrier, which can change the URL at any point in time and still be able to provide the ability for a new device which has not been initialized to contact the voicemail server through a URL provided by the service provider, such as a public telephone carrier.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine implemented method comprising:
receiving data representative of a voicemail at a mobile data processing system;
receiving an instruction to delete the voicemail at the mobile data processing system;
storing data indicating that the voicemail has been marked for deletion at the mobile data processing system in response to the receiving of the instruction;
receiving a further instruction to delete the voicemail at the mobile data processing system and deleting the data representative of the voicemail in response to the further instruction.

2. The method as in claim 1, the method further comprising:
transmitting an instruction to a server data processing system to delete the voicemail in response to the further instruction, and wherein the voicemail is not deleted at the server data processing system until after receiving the further instruction.

3. The method as in claim 2, the method further comprising:
removing the voicemail from a list in response to the instruction to delete and adding the voicemail to a delete list in response to the instruction to delete; and
removing the voicemail from the delete list in response to the further instruction.

4. The method as in claim 3 wherein the mobile data processing system comprises a cellular telephone and wherein the server data processing system is operated by a wireless cellular telephone carrier.

5. The method as in claim 4 wherein the data representative of the voicemail is at least one of (a) a notification of the voicemail and (b) a download of content of the voicemail, and wherein a date of the receiving of the instruction is stored in response to the receiving of the instruction, and wherein the delete list represents a delete folder for voicemails.

6. A machine readable medium containing executable instructions which cause a system to perform a method comprising:
receiving data representative of a voicemail at a mobile data processing system;
receiving an instruction to delete the voicemail at the mobile data processing system;
storing data indicating that the voicemail has been marked for deletion at the mobile data processing system in response to the receiving of the instruction;
receiving a further instruction to delete the voicemail at the mobile data processing system and deleting the data representative of the voicemail in response to the further instruction.

7. The medium as in claim 6, the method further comprising:
transmitting an instruction to a server data processing system to delete the voicemail in response to the further instruction, and wherein the voicemail is not deleted at the server data processing system until after receiving the further instruction.

8. The medium as in claim 7, the method further comprising:
removing the voicemail from a list in response to the instruction to delete and adding the voicemail to a delete list in response to the instruction to delete; and
removing the voicemail from the delete list in response to the further instruction.

9. The medium as in claim 8 wherein the mobile data processing system comprises a cellular telephone and wherein the server data processing system is operated by a wireless cellular telephone carrier.

10. The medium as in claim 9 wherein the data representative of the voicemail is at least one of (a) a notification of the voicemail and (b) a download of content of the voicemail, and wherein a date of the receiving of the instruction is stored in response to the receiving of the instruction, and wherein the delete list represents a delete folder for voicemails.

11. A data processing system comprising:
means for receiving data representative of a voicemail at a mobile data processing system;
means for receiving an instruction to delete the voicemail at the mobile data processing system;
means for storing data indicating that the voicemail has been marked for deletion at the mobile data processing system in response to the receiving of the instruction;
means for receiving a further instruction to delete the voicemail at the mobile data processing system and deleting the data representative of the voicemail in response to the further instruction.

12. A mobile data processing system comprising:
a wireless transceiver;
a processor coupled to the wireless transceiver;
a memory coupled to the processor, the processor and memory being configured to receive at least notifications of voicemails at the mobile data processing system and being configured to store a data structure, at the mobile data processing system, for deleted voicemails.

13. The mobile data processing system as in claim 12 wherein the wireless transceiver comprises a wireless cellular telephone transceiver and wherein data for a voicemail is stored in the data structure in response to an instruction to delete the voicemail and wherein the data for the voicemail is deleted from the data structure in response to a further instruction to delete the voicemail.

14. The mobile data processing system as in claim 13 wherein the wireless transceiver receives the notifications of the voicemails and transmits an instruction, in response to the further instruction, to delete the voicemail at a server data processing system which is operated by a wireless cellular telephone carrier.

15. The mobile data processing system as in claim 14 wherein the content of the voicemail is downloaded, from the server data processing system, to the mobile data processing system before the voicemail is deleted in response to the further instruction and wherein the data structure represents a delete folder for voicemails.

16. A machine implemented method comprising:
receiving at least notifications of voicemails at a mobile data processing system;
storing a data structure at the mobile data processing system for deleted voicemails.

17. The method as in claim 16 wherein the mobile data processing system comprises a wireless cellular telephone transceiver which receives the notifications and wherein the method further comprises:
receiving an instruction to delete a voicemail, wherein data for the voicemail is stored in the data structure in response to the instruction;
receiving a further instruction to delete the voicemail, wherein data for the voicemail is deleted from the data structure in response to the further instruction.

18. The method as in claim 17 wherein the wireless cellular telephone transceiver transmits an instruction, in response to the further instruction, to delete the voicemail at a server data processing system which is operated by a wireless cellular telephone carrier.

19. The method as in claim 18 wherein the data structure represents a delete folder for voicemails and wherein the content of the voicemail is downloaded, from the server data processing system, to the mobile data processing system before the voicemail is deleted in response to the further instruction.

20. A machine readable medium containing executable instructions which cause a system to perform a method comprising:
receiving at least notifications of voicemails at a mobile data processing system;
storing a data structure at the mobile data processing system for deleted voicemails.

21. The medium as in claim 20 wherein the mobile data processing system comprises a wireless cellular telephone transceiver which receives the notifications and wherein the method further comprises:
receiving an instruction to delete a voicemail, wherein data for the voicemail is stored in the data structure in response to the instruction;
receiving a further instruction to delete the voicemail, wherein data for the voicemail is deleted from the data structure in response to the further instruction.

22. The medium as in claim 21 wherein the wireless cellular telephone transceiver transmits an instruction, in response to the further instruction, to delete the voicemail at a server data processing system which is operated by a wireless cellular telephone carrier.

23. The medium as in claim 22 wherein the data structure represents a delete folder for voicemails and wherein the content of the voicemail is downloaded, from the server data processing system, to the mobile data processing system before the voicemail is deleted in response to the further instruction.

24. A data processing system comprising:
means for receiving at least notifications of voicemails at a mobile data processing system;
means for storing a data structure at the mobile data processing system for deleted voicemails.

25. A machine implemented method comprising:
determining an extent of usage of a voicemail mailbox at a data processing system;
determining a period of time representing how long a voicemail has been marked as deleted;
determining, based on the extent of usage and based on the period of time, whether to delete the voicemail.

26. The method as in claim 25, wherein the method further comprises:
deleting the voicemail in response to the determining whether to delete the voicemail; and wherein the data processing system is a server data processing system which is operated by a wireless cellular telephone carrier.

27. The method as in claim 26, wherein the method further comprises:
determining whether the extent of usage exceeds a threshold;
and wherein the voicemail is deleted at the server data processing system and at a mobile data processing system.

28. The method as in claim 26 wherein the server data processing system performs the determining of the extent and a mobile data processing system performs automatically the determining whether to delete.

29. The method as in claim 26 wherein the method is performed at the server data processing system.

30. The method as in claim 26 wherein the method is performed at a mobile data processing system which comprises a wireless cellular telephone transceiver.

31. A machine readable medium containing executable instructions which cause a system to perform a method comprising:
determining an extent of usage of a voicemail mailbox at a data processing system;
determining a period of time representing how long a voicemail has been marked as deleted;
determining, based on the extent of usage and based on the period of time, whether to delete the voicemail.

32. The medium as in claim 31, wherein the method further comprises:
deleting the voicemail in response to the determining whether to delete the voicemail; and wherein the data processing system is a server data processing system which is operated by a wireless cellular telephone carrier.

33. The medium as in claim 32, wherein the method further comprises:
determining whether the extent of usage exceeds a threshold;
and wherein the voicemail is deleted at the server data processing system and at a mobile data processing system.

34. The medium as in claim 32 wherein the server data processing system performs the determining of the extent and a mobile data processing system performs automatically the determining whether to delete.

35. The medium as in claim 32 wherein the method is performed at the server data processing system.

36. The medium as in claim 32 wherein the method is performed at a mobile data processing system which comprises a wireless cellular telephone transceiver.

37. A machine comprising:
means for determining an extent of usage of a voicemail mailbox at a data processing system;
means for determining a period of time representing how long a voicemail has been marked as deleted;
means for determining, based on the extent of usage and based on the period of time, whether to delete the voicemail.

38. A machine implemented method comprising:
receiving, at a first data processing system, data representing an extent of usage of a voicemail mailbox at a second data processing system;
determining a period of time which represents how long a voicemail has been marked as deleted at the first data processing system;
determining, based on the extent of usage and based on the period of time, whether to delete the voicemail.

39. The method as in claim 38 wherein the method further comprises:
deleting the voicemail at the second data processing system in response to the determining whether to delete the voicemail; and wherein the second data processing system is a server data processing system which is operated by a wireless cellular telephone carrier.

40. The method as in claim 39, wherein the data representing the extent of usage indicates whether the extent of usage exceeds a threshold and wherein at least data representing the voicemail is deleted at the first data processing system in response to the determining whether to delete the voicemail and wherein the first data processing system comprises a wireless cellular telephone.

41. The method as in claim 40, wherein the at least data representing the voicemail is deleted automatically without user input.

42. The method as in claim 40, wherein the at least data representing the voicemail is deleted after presenting information about the deletion to a user.

43. The method as in claim 40, the method further comprising:
receiving at the first data processing system, content of the voicemail and storing the content on the first data processing system.

44. A machine readable medium containing executable instructions which cause a system to perform a method comprising:
receiving, at a first data processing system, data representing an extent of usage of a voicemail mailbox at a second data processing system;
determining a period of time which represents how long a voicemail has been marked as deleted at the first data processing system;
determining, based on the extent of usage and based on the period of time, whether to delete the voicemail.

45. The medium as in claim 44 wherein the method further comprises:
deleting the voicemail at the second data processing system in response to the determining whether to delete the voicemail; and wherein the second data processing system is a server data processing system which is operated by a wireless cellular telephone carrier.

46. The medium as in claim 45, wherein the data representing the extent of usage indicates whether the extent of usage exceeds a threshold and wherein at least data representing the voicemail is deleted at the first data processing system in response to the determining whether to delete the voicemail and wherein the first data processing system comprises a wireless cellular telephone.

47. The medium as in claim 46, wherein the at least data representing the voicemail is deleted automatically without user input.

48. The medium as in claim 46, wherein the at least data representing the voicemail is deleted after presenting information about the deletion to a user.

49. The medium as in claim 46, the method further comprising:
receiving at the first data processing system, content of the voicemail and storing the content on the first data processing system.

50. A machine comprising:
means for receiving, at a first data processing system, data representing an extent of usage of a voicemail mailbox at a second data processing system;
means for determining a period of time which represents how long a voicemail has been marked as deleted at the first data processing system;
means for determining, based on the extent of usage and based on the period of time, whether to delete the voicemail.

51. A machine implemented method comprising:
transmitting, from a first data processing system, time data which represents when a voicemail has been marked as deleted at the first data processing system;
storing, at the first data processing system, voicemail data for the voicemail after the transmitting;
deleting, at the first data processing system, the voicemail data in response to an instruction from a second data processing system, wherein the deleting occurs after the storing.

52. The method as in claim 51 wherein the first data processing system comprises a wireless cellular telephone and the second data processing system is a voicemail server operated by a wireless cellular telephone carrier.

53. The method as in claim 51 wherein the time data comprises a date of deletion at the first data processing system and wherein the voicemail data comprises at least one of metadata of the voicemail and content of the voicemail.

54. The method as in claim 53 wherein the content is downloaded to and stored at the first data processing system.

55. The method as in claim 53 wherein the voicemail data is deleted automatically without user input.

56. The method as in claim 53 wherein the voicemail data is deleted after presenting information about the deletion to a user.

57. A machine readable medium containing executable instructions which cause a system to perform a method comprising:
transmitting, from a first data processing system, time data which represents when a voicemail has been marked as deleted at the first data processing system;
storing, at the first data processing system, voicemail data for the voicemail after the transmitting;
deleting, at the first data processing system, the voicemail data in response to an instruction from a second data processing system, wherein the deleting occurs after the storing.

58. The medium as in claim 57 wherein the first data processing system comprises a wireless cellular telephone and the second data processing system is a voicemail server operated by a wireless cellular telephone carrier.

59. The medium as in claim 57 wherein the time data comprises a date of deletion at the first data processing system and wherein the voicemail data comprises at least one of metadata of the voicemail and content of the voicemail.

60. The medium as in claim 59 wherein the content is downloaded to and stored at the first data processing system.

61. The medium as in claim 59 wherein the voicemail data is deleted automatically without user input.

62. The medium as in claim 59 wherein the voicemail data is deleted after presenting information about the deletion to a user.

63. A machine comprising:
means for transmitting, from a first data processing system, time data which represents when a voicemail has been marked as deleted at the first data processing system;
means for storing, at the first data processing system, voicemail data for the voicemail after the transmitting;
means for deleting, at the first data processing system, the voicemail data in response to an instruction from a second data processing system, wherein the deleting occurs after the storing.

64. A mobile data processing system comprising:
a wireless transceiver;
a processor coupled to the wireless transceiver;
a memory coupled to the processor, the processor being configured to transmit, through the wireless transceiver, time data which represents when a voicemail has been marked as deleted at the mobile data processing system, and the memory is configured to store voicemail data for the voicemail after the time data is transmitted, and the processor being configured to delete the voicemail data at the mobile data processing system in response to an instruction from a second data processing system.

65. The mobile data processing system as in claim 64 wherein the time data comprises a date of deletion at the mobile data processing system and wherein the voicemail data comprises at least one of metadata of the voicemail and content of the voicemail.

66. The mobile data processing system as in claim 65 wherein the processor is configured to download the content and to store the content in the memory.

67. A machine implemented method comprising:
receiving, at a first data processing system, time data which represents when a voicemail has been marked as deleted at a second data processing system;
determining whether a voicemail mailbox of the first data processing system has a usage which exceeds a threshold, wherein the voicemail is at least temporarily stored in the voicemail mailbox;
determining whether to delete the voicemail based on the time data and whether the usage exceeds the threshold.

68. The method as in claim 67 wherein the first data processing system comprises a voicemail server data processing system and the second data processing system comprises a mobile wireless cellular telephone and wherein the voicemail server data processing system is operated by a wireless cellular telephone carrier.

69. The method as in claim 67 wherein the time data comprises a date of deletion at the second data processing system and wherein the voicemail is stored as voicemail data which comprises at least one of metadata of the voicemail and content of the voicemail.

70. The method as in claim 69 wherein the content is downloaded to and stored at the second data processing system.

71. The method as in claim 67 wherein the voicemail is deleted automatically without user input.

72. The method as in claim 67 wherein the voicemail is deleted after presenting information about the deletion to a user.

73. A machine readable medium containing executable instructions which cause a system to perform a method comprising:
receiving, at a first data processing system, time data which represents when a voicemail has been marked as deleted at a second data processing system;
determining whether a voicemail mailbox of the first data processing system has a usage which exceeds a threshold, wherein the voicemail is at least temporarily stored in the voicemail mailbox;
determining whether to delete the voicemail based on the time data and whether the usage exceeds the threshold.

74. The medium as in claim 73 wherein the first data processing system comprises a voicemail server data processing system and the second data processing system comprises a mobile wireless cellular telephone and wherein the voicemail server data processing system is operated by a wireless cellular telephone carrier.

75. The medium as in claim 73 wherein the time data comprises a date of deletion at the second data processing system and wherein the voicemail is stored as voicemail data which comprises at least one of metadata of the voicemail and content of the voicemail.

76. The medium as in claim 75 wherein the content is downloaded to and stored at the second data processing system.

77. The medium as in claim 73 wherein the voicemail is deleted automatically without user input.

78. The medium as in claim 73 wherein the voicemail is deleted after presenting information about the deletion to a user.

79. A machine comprising:
means for receiving, at a first data processing system, time data which represents when a voicemail has been marked as deleted at a second data processing system;
means for determining whether a voicemail mailbox of the first data processing system has a usage which exceeds a threshold, wherein the voicemail is at least temporarily stored in the voicemail mailbox;
means for determining whether to delete the voicemail based on the time data and whether the usage exceeds the threshold.

80. A data processing system comprising:
a network interface;
a processor coupled to the network interface;
a memory coupled to the processor, the processor being configured to receive time data which represents when a voicemail has been marked as deleted at a mobile wireless system, and the processor is configured to determine whether a voicemail mailbox has a usage which exceeds a threshold and is configured to determine whether to delete the voicemail based on the time data and whether the usage exceeds the threshold.

81. The data processing system as in claim 80, wherein the time data comprises a date of deletion at the mobile wireless system and wherein the voicemail is stored as voicemail data which comprises at least one of metadata of the voicemail and content of the voicemail.

82. The data processing system as in claim 81 wherein the content is downloaded to and stored at the mobile wireless system.

83. The data processing system as in claim 81 wherein the voicemail is deleted automatically without user input.

84. The data processing system as in claim 81 wherein the voicemail is deleted after presenting information about the deletion to a user.

85. A machine implemented method comprising:
receiving first data which indicates whether use of a voicemail mailbox exceeds a threshold;
determining whether a voicemail marked for deletion has been marked for deletion for more than a period of time;
deleting the voicemail if (a) the first data indicates that the threshold has been exceeded and (b) the voicemail has been marked for deletion for more than the period of time.

86. The method as in claim 85 wherein the first data is received at a mobile wireless data processing system which comprises a wireless cellular telephone and wherein the mobile wireless data processing system performs the determining and the deleting.

87. The method as in claim 86 wherein the deleting is performed automatically without user input.

88. The method as in claim 86 wherein the deleting is performed after presenting information about the deleting to a user.

89. The method as in claim 86 wherein the deleting deletes the voicemail in the voicemail mailbox at a voicemail server and deletes at least one of metadata of the voicemail and content of the voicemail at the mobile wireless data processing system.

90. The method as in claim 89 wherein the content is downloaded to the mobile wireless data processing system.

91. A machine readable medium containing executable instructions which cause a system to perform a method comprising:
receiving first data which indicates whether use of a voicemail mailbox exceeds a threshold;
determining whether a voicemail marked for deletion has been marked for deletion for more than a period of time;
deleting the voicemail if (a) the first data indicates that the threshold has been exceeded and (b) the voicemail has been marked for deletion for more than the period of time.

92. The medium as in claim 91 wherein the first data is received at a mobile wireless data processing system which comprises a wireless cellular telephone and wherein the mobile wireless data processing system performs the determining and the deleting.

93. The medium as in claim 92 wherein the deleting is performed automatically without user input.

94. The medium as in claim 92 wherein the deleting is performed after presenting information about the deleting to a user.

95. The medium as in claim 92 wherein the deleting deletes the voicemail in the voicemail mailbox at a voicemail server and deletes at least one of metadata of the voicemail and content of the voicemail at the mobile wireless data processing system.

96. The medium as in claim 95 wherein the content is downloaded to the mobile wireless data processing system.

97. A machine comprising:
means for receiving first data which indicates whether use of a voicemail mailbox exceeds a threshold;
means for determining whether a voicemail marked for deletion has been marked for deletion for more than a period of time;
means for deleting the voicemail if (a) the first data indicates that the threshold has been exceeded and (b) the voicemail has been marked for deletion for more than the period of time.

98. A data processing system comprising:
a wireless transceiver;
a processor coupled to the wireless transceiver;
a memory coupled to the processor, the processor being configured to receive first data which indicates whether use of a voicemail mailbox exceeds a threshold and being configured to determine whether a voicemail marked for deletion has been marked for deletion for more than a period of time and being configured to delete the voicemail if (a) the first data indicates that the threshold has been exceeded and (b) the voicemail has been marked for deletion for more than a period of time.

99. The data processing system as in claim 98 wherein the processor is configured to download content of the voicemail to the memory.

100. The machine implemented method comprising:
presenting a preview user interface (UI) object on a telephone device, the preview UI object being configured to receive an input to cause a presentation of a preview of a voicemail;
receiving the input;
presenting the preview in response to receiving the input.

101. A machine implemented method at a voicemail server, the method comprising:
storing a voicemail on a storage device coupled to the voicemail server;
receiving an instruction to delete the voicemail and, in response to the instruction, storing the voicemail in a data structure for deleted voicemails.
